(19) United States
(12) Patent Application Publication
(10) Pub. No.: US 2007/0013626 A1
(43) Pub. Date: Jan. 18, 2007

(54) Display apparatus

(75) Inventors: Tomohiro Ando, Tokyo (JP); Rintarou Takahashi, Tokorozawa-shi (JP); Satoshi Imoto, Sayama-shi (JP); Takashi Akiyama, Sayama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CITIZEN WATCH CO., LTD.

(21) Appl. No.: 11/482,060

(22) Filed: Jul. 7, 2006

(30) Foreign Application Priority Data
Jul. 7, 2005 (JP) 2005-198448

(51) Int. Cl. G09G 3/36

(52) U.S. Cl. 345/88

(57) ABSTRACT

In a display apparatus, the number of wiring patterns to be routed on an interface board (FPC) connected to a display panel is reduced, thus reducing the size of the interface board and thereby reducing the overall size of the display apparatus. The display apparatus includes a display panel which displays a plurality of color component images by sequentially switching from one image to another, a panel driving section which outputs a timing signal and a panel driving signal for driving the display panel, a light source which emits a plurality of colored lights, and a light source driving section which outputs a driving signal for driving the light source in synchronism with the timing signal.

This application is a new U.S. patent application that claims benefit of JP 2005-198448, filed on Jul. 7, 2005. The entire content of JP 2005-198448 is hereby incorporated by reference.

### FIELD OF THE INVENTION

The present invention relates to a display apparatus which obtains a desired white light display by adjusting the driving of red (R), green (G), and blue (B) light sources. More particularly, the invention relates to a display apparatus wherein provisions are made for optimization of display images in a field-sequential display system which produces a color image by sequentially emitting a plurality of light-emitting devices that emit light at different wavelengths.

### BACKGROUND OF THE INVENTION

It is known in the art to use light-emitting devices, typically LEDs, that emit light at wavelengths corresponding to R, G, and B colors, as backlighting devices, i.e., as illuminating devices, in a display apparatus constructed using an electro-optical conversion member. In such a display apparatus, the light-emitting devices emit in sequence at a predetermined rate, and a color image is produced by exploiting the visual persistence of the human eye. This type of display apparatus, generally known as a field-sequential display apparatus, has the characteristic that its light transmittance is high and it can produce very bright color images, because the display does not use color filters. However, as the luminous efficiency of LEDs greatly differs depending on the colors they produce, and the threshold voltages (Vth) also differ, the problem is that the chromaticity of the produced light differs between individual LEDs even if they are driven with the same driving voltage. Accordingly, such a field-sequential display apparatus has the problem that a color image cannot be displayed with uniform color intensity.

In view of the above, it is known to provide a technique that addresses the issue of contrast nonuniformity (for example, refer to patent document 1). According to the technique disclosed in the patent document 1, the contrast is optimized by controlling the white balance which is adjusted by changing the emitting duration of each of the R, G, and B colors.

FIG. 20 is a schematic block diagram of a prior art color display apparatus shown in patent document 1.

In FIG. 20, the color display apparatus 300 has a light source section 301. The light source section 301 includes light-emitting diodes (LEDs) 301a, 301b, and 301c which emit light of R, G, and B colors, respectively. The LEDs 301a, 301b, and 301c are driven by light source drive currents 306a, 306b, and 306c supplied from a light source driving circuit 321. A liquid crystal panel 304 is driven by a display drive signal 307 supplied from a liquid crystal driving circuit 322. A color image is displayed on the liquid crystal panel 304 by an output light (indicated by arrow A) produced by the red LED 301a, the green LED 301b, and the blue LED 301c in the light source section 301.

A control section 323 contains a synchronization control circuit 325 and a display memory circuit 326. A time memory circuit 324 is constructed from a nonvolatile memory such as a flash memory, and outputs time memory data 324a to the control section 323. An interface circuit 327, which is a means for providing an electrical connection with the outside, receives external information and supplies it to the time memory circuit 324. The time memory circuit 324 stores the external information supplied via the interface circuit 324 as emitting duration time information for the LEDs 301a, 301b, and 301c, and supplies the stored emitting duration time information as the time memory data 324a to the synchronization control circuit 325 in the control section 323.

The synchronization control circuit 325 in the control section 323 receives the time memory data 324a, and supplies the light source driving circuit 321 with light source timing signals LED-R, LED-G, and LED-B which determine the emitting timings of the respective LEDs 301a, 301b, and 301c in the light source section 301. Further, the synchronization control circuit 325 supplies the display memory circuit 326 with color select signals SL-R, SL-G, and SL-B synchronized to the respective light source timing signals LED-R, LED-G, and LED-B. Based on the color select signals SL-R, SL-G, and SL-B, the display memory circuit 326 supplies its internally stored display information as display data DT to the liquid crystal driving circuit 322.

A power supply section 328 supplies necessary power to the light source driving circuit 321, the liquid crystal driving circuit 322, and the control circuit 323. A computer 330, which is external to the color display apparatus 300, functions as an external control section for creating the emitting duration time information and supplies time control data 330e to the interface circuit 327. A luminance colorimeter 331 measures the luminance and chromaticity of light (indicated by arrow B) transmitted through the liquid crystal panel 304, and generates chromaticity data 331a which is supplied to the computer 330. The luminance colorimeter 331 and the computer 330 are connected to the interface circuit 327 when adjusting the white balance and, once the adjustment is done, they are disconnected from the circuit. The computer 330 has an operation section used to enter information and a display section for displaying computation results, etc.

Next, a description will be given of how the white balance is adjusted in the color display apparatus shown in FIG. 20.

First, initial values of emitting duration time data, etc. for the red, green, and blue LEDs 301a, 301b, and 301c are stored via the computer 330 into the time memory circuit 324. Next, the initial values of emitting duration time data stored in the time memory circuit 324 are read out and supplied to the synchronization control circuit 325 in the control section 323. The synchronization control circuit 325 then generates the light source timing signals LED-R, LED-G, and LED-B and supplies them to the light source driving circuit 321. Based on the light source timing signals LED-R, LED-G, and LED-B, the light source driving circuit 321 supplies the light source drive currents 306a, 306b, and 306c to the light source section 301. The LEDs 301a, 301b, and 301c in the light source section 301 are driven to flash in accordance with the light source timing signals LED-R, LED-G, and LED-B.

Further, in synchronism with the light source timing signals LED-R, LED-G, and LED-B output from the synchronization control circuit 325, the color select signals SL-R, SL-G, and SL-B are output from the synchronization control circuit 325 to the display memory circuit 326. The display memory circuit 326 then supplies the stored display information as the display data DT to the liquid crystal driving circuit 322 in response to the received color select signals SL-R, SL-G, and SL-B. The liquid crystal driving circuit 322 drives the liquid crystal panel 304 by supplying the display drive signal 307 to the liquid crystal panel 304 based on the display data DT.

The red LED 301a, the green LED 301b, and the blue LED 301c are flashed in sequence in synchronism with the driving of the liquid crystal panel 304. The output light (indicated by arrow A) produced by the LEDs 301a, 301b, and 301c is transmitted through the liquid crystal panel 304 being driven, and the transmitted light (indicated by arrow B) emerges from the front side of the liquid crystal panel 304. The chromaticity of the transmitted light emerging from the front side is measured by the luminance colorimeter 331, and the chromaticity data 331a is input to the computer 330. The computer 330 determines whether the chromaticity data 331a falls within predetermined limits.

If it is determined that the chromaticity data 331a is outside the predetermined limits, a correction value is obtained for the emitting duration time. Next, by operating the operation section of the computer 330, the time control data 330e corrected with the correction value is stored in the time memory circuit 324 via the interface circuit 327. Next, based on the time control data 330e corrected with the correction value, the emitting of the LEDs 301a, 301b, and 301c and the driving of the liquid crystal panel 304 are performed, and the chromaticity data 331a is measured a second time. Next, the chromaticity data 331a measured for the second time is input to the computer 330 to determine whether it falls within the limits. The operation is repeated until the chromaticity data 331a falls within the predetermined limits, and the white balance is thus optimized.

With the above method of adjustment, the emitting duration times of the red LED 301a, the green LED 301b, and the blue LED 301c are set so as to optimize the white balance.

Patent Document 1: Japanese Unexamined Patent Publication No. 2004-86081

### SUMMARY OF THE INVENTION

In the color display apparatus 300 shown in FIG. 20, the emitting duration times of the red LED 301a, the green LED 301b, and the blue LED 301c are adjusted so as to optimize the white balance. However, the color display apparatus 300 is constructed by including the control section 323 that contains the synchronization control circuit 325, the display memory circuit 326, etc. The circuits in the control section 323, even if mounted on the circuit board of the interface circuit 327, require the formation of complex circuit patterns and consume a large area for mounting. Accordingly, this circuit configuration is not suitable for a display apparatus that must be mounted within a small and restricted space, such as a liquid crystal display used in a portable telephone or the like. Furthermore, as the configuration requires the use of a computer, the equipment cost, etc. increase.

In view of the above situation, it is an object of the present invention to provide a display apparatus wherein provisions are made to be able to effectively adjust the white balance, while achieving a reduction in size so that the apparatus can be mounted in a restricted space.

A display apparatus according to the present invention includes a liquid crystal display panel which displays red, green, and blue component images by sequentially switching from one image to another, a panel driving section which outputs a timing signal and a panel driving signal for driving the liquid crystal display panel, a light source having a red LED, a green LED, and a blue LED, a setting section for setting the brightness of each of the red, green, and blue LEDs, an adjusting section which, based on the setting made by the setting section, outputs adjusting data for adjusting the brightness of each of the red, green, and blue LEDs, and a light source driving section which flashes, based on the adjusting data, the red LED, the green LED, and the blue LED by sequentially switching from one LED to another in synchronism with the timing signal.

Preferably, in the display apparatus according to the present invention, the setting section has a plurality of conductive pattern circuits, and the setting in the setting section is done by making non-conductive at least one conductive pattern circuit selected from among the plurality of conductive pattern circuits.

Preferably, in the display apparatus according to the present invention, the setting section has a plurality of non-conductive pattern circuits, and the setting in the setting section is done by making conductive at least one non-conductive pattern circuit selected from among the plurality of non-conductive pattern circuits.

Preferably, in the display apparatus according to the present invention, the setting section has a memory, and the setting in the setting section is done by writing to the memory.

Preferably, the display apparatus according to the present invention further includes an external circuit connecting board for transmitting display data to the panel driving section.

Preferably, in the display apparatus according to the present invention, the light source, the setting section, and the light source driving section are provided on the external circuit connecting board.

Preferably, in the display apparatus according to the present invention, the external circuit connecting board comprises a first FPC board and a second FPC board, wherein the light source section and the light source driving section are provided on the first FPC board, while the setting section is provided on the second FPC board, further preferably, the first FPC board and the second FPC board are formed integrally.

Preferably, in the display apparatus according to the present invention, the panel driving section and the adjusting section are provided within the same IC.

Preferably, in the display apparatus according to the present invention, the panel driving section, the light source driving section, and the adjusting section are provided within the same IC.

Preferably, in the display apparatus according to the present invention, the panel driving section, the adjusting section, and the setting section are provided within the same IC.

Preferably, in the display apparatus according to the present invention, the panel driving section, the light source driving section, the adjusting section, and the setting section are provided within the same IC.

A display apparatus according to the present invention includes a display panel which displays a plurality of color component images by sequentially switching from one image to another, a panel driving section which outputs a timing signal and a panel driving signal for driving the display panel, a light source which emits a plurality of colored lights, and a light source driving section which outputs a driving signal for driving the light source in synchronism with the timing signal.

A display apparatus according to the present invention includes a panel driving section which outputs a panel driving signal for driving a display panel, a light source which emits a plurality of colored lights, and an adjusting section which outputs adjusting data for adjusting the brightness of each of the plurality of colored lights to be emitted from the light source, wherein the panel driving section and the adjusting section are provided within the same IC.

Preferably, the display apparatus according to the present invention further includes a light source driving section which, based on the adjusting data, outputs a driving signal for driving the light source, wherein the panel driving section, the light source driving section, and the adjusting section are provided within the same IC.

Preferably, the display apparatus according to the present invention further includes a setting section for setting the brightness of each of the plurality of colored lights to be emitted from the light source wherein, based on the setting made by the setting section, the adjusting section outputs the adjusting data for adjusting the brightness of each of the plurality of colored lights to be emitted from the light source, and the panel driving section, the setting section, and the adjusting section are provided within the same IC.

Preferably, the display apparatus according to the present invention further includes a setting section for setting the brightness of each of the plurality of colored lights to be emitted from the light source, and a light source driving section which, based on the adjusting data, outputs a driving signal for driving the light source wherein, based on the setting made by the setting section, the adjusting section outputs the adjusting data for adjusting the brightness of each of the plurality of colored lights to be emitted from the light source, and the panel driving section, the light source driving section, the setting section, and the adjusting section are provided within the same IC.

A display apparatus according to the present invention includes a panel driving section which outputs a timing signal and a panel driving signal for driving a display panel, a light source which emits a plurality of colored lights, an adjusting section which outputs adjusting data for adjusting the brightness of each of the plurality of colored lights to be emitted from the light source section, and a light source driving section which outputs a driving signal for driving the light source in synchronism with the timing signal, wherein the panel driving section and the adjusting section are provided within the same IC.

A display apparatus according to the present invention includes an illumination device driven by a light source driving IC and a display panel driven by a panel driving IC, wherein the light source driving IC drives the illumination device in synchronism with an output from the panel driving IC.

Preferably, in the display apparatus according to the present invention, the illumination device includes a light source, and the light source is a light-emitting diode (LED).

Further preferably, in the display apparatus according to the present invention, the output from the panel driving IC is a timing signal for the light source driving IC.

A display apparatus according to the present invention includes an illumination device which includes at least a light source, and a display panel which is illuminated with light from the light source, wherein a timing signal for a light source driving IC for driving the light source is obtained from a panel driving IC which drives the display panel.

Preferably, in the display apparatus according to the present invention, the light source is a light-emitting diode (LED).

Preferably, in the display apparatus according to the present invention, the display panel is a liquid crystal display that uses a liquid crystal as an electro-optical conversion member.

Preferably, in the display apparatus according to the present invention, the panel driving IC includes an adjusting circuit for setting the timing signal to a predetermined value.

Preferably, in the display apparatus according to the present invention, the adjusting circuit is provided with an adjusting value setting section for setting the timing signal to a predetermined value, and the adjusting value setting section is provided outside the panel driving IC.

Preferably, in the display apparatus according to the present invention, at least an external circuit connecting board for delivering signals to the panel driving IC is connected to the display panel, wherein the adjusting value setting section of the adjusting circuit, the light source driving IC, and the light source are accommodated on the external circuit connecting board.

Preferably, in the display apparatus according to the present invention, at least an external circuit connecting board for delivering signals to the panel driving IC is connected to the display panel, wherein the light source driving IC and the light source are accommodated on the external circuit connecting board, while the adjusting value setting section of the adjusting circuit is formed on an adjusting value setting board provided separately from the external circuit connecting board.

Preferably, in the display apparatus according to the present invention, the setting of an adjusting value in the adjusting value setting section is done by punching a hole in at least one conductive pattern circuit formed on the external circuit connecting board or on the adjusting value setting board.

Preferably, in the display apparatus according to the present invention, the setting of an adjusting value in the adjusting value setting section is done by making a non-conductive portion conductive in at least one pattern circuit formed on the external circuit connecting board or on the adjusting value setting board.

Preferably, in the display apparatus according to the present invention, the non-conductive portion is made conductive by soldering.

Preferably, in the display apparatus according to the present invention, the external circuit connecting board or the adjusting value setting board is a flexible board.

A display apparatus according to the present invention is a field-sequential display apparatus includes a black-and-white liquid crystal display panel which displays at least red, green, and blue component images by switching from one image to another, and red, green, and blue LEDs which are switched from one to another to illuminate the black-and-white liquid crystal display panel in synchronism with the switching timing of the component images displayed on the black-and-white liquid crystal display panel, wherein a timing signal for an LED driving IC which drives the red, green, and blue LEDs by switching from one to another is obtained from a panel driving IC which drives the black-and-white liquid crystal display panel.

In the display apparatus according to the present invention, the panel driving IC for driving the display panel and the light source for illuminating the display panel are mounted in close vicinity to the display panel, and the light source driving IC for driving the light source is mounted in close vicinity to the light source. Accordingly, the panel driving IC and the light source driving IC are located relatively close to each other. Further, in the display apparatus according to the present invention, the timing signal supplied from an external control circuit to the panel driving IC is taken out from the panel driving IC and supplied to the light source driving IC. There is therefore no need to route a wiring pattern from the external control circuit directly to the light source driving IC and, hence, the number of long wiring patterns can be reduced. With this configuration, the length of the wiring pattern can be shortened, which serves to reduce the circuit area required for the wiring pattern, etc. and also reduce the wiring resistance. Accordingly, the display apparatus can be reduced in size, and can thus be made to fit into a restricted space.

In the display apparatus according to the present invention, the light source comprises a red LED, a green, LED, and a blue LED, and white light is produced by mixing the colored lights from the red, green, and blue LEDs. Further, any desired color can be produced using the red, green, and blue LEDs. That is, a full-color image can be displayed on the display panel. Because of their compact sizes and low cost, LEDs can be used advantageously as light sources for illuminating small-sized display apparatus. Furthermore, as LEDs operate on low voltages, power consumption can be reduced, and the production cost of the display apparatus can also be reduced.

In the display apparatus according to the present invention, as the display panel is constructed from a liquid crystal display panel that uses a liquid crystal as an electro-optical conversion member, the display can be driven at low voltage and the power consumption can be reduced. Also, the display apparatus can be mounted in a restricted space, because the liquid crystal panel can be made thin and compact in construction.

In the display apparatus according to the present invention, the panel driving IC includes an adjusting circuit for setting the timing signal for each of the red, green, and blue LEDs to a predetermined pulse width value, and the timing signals that the light source driving IC supplies to the red, green, and blue LEDs are each set to an optimum pulse width value by the setting circuit. This achieves an optimum white balance and well-balanced RGB chromaticity and, thus, a color image of uniform contrast can be obtained.

In the display apparatus according to the present invention, the adjusting circuit is provided with an adjusting value setting section for setting the timing signal to a predetermined pulse width value, and the adjusting value setting section is provided outside the panel driving IC. By providing the adjusting value setting section outside the panel driving IC, the adjusting value can be set after completing the fabrication of the liquid crystal panel; accordingly, the setting of the adjusting value can be accomplished using a simple structure.

In the display apparatus according to the present invention, as the adjusting value setting section is provided on the (external circuit) connecting board together with the light source driving IC and the light source, the adjusting value setting section can be arranged in a position near the panel driving IC, the light source driving IC, and the light source. This arrangement serves to shorten the wiring pattern and hence reduce the area of the connecting board. As a result, the cost of the connecting board can be reduced. Furthermore, shortening the wiring pattern contributes to reducing the wiring resistance. Shortening the wiring pattern has the further effect of preventing noise generation and noise pickup and enhancing the reliability of control.

In the display apparatus according to the present invention, when setting the adjusting value in the adjusting value setting section by punching or not punching holes in the conductive pattern circuits, as the adjusting value can be set by simply punching holes, the setting method is simple and the setting can be done at low cost using a simple tool.

In the display apparatus according to the present invention, when setting the adjusting value in the adjusting value setting section by making the non-conductive pattern circuits conductive or leaving them non-conductive, as the adjusting value can be set by soldering or by applying an electrically conductive adhesive, the setting method is simple and the setting can be done at low cost. Here, when making the non-conductive pattern circuits conductive by soldering, a good conduction quality can be achieved because the electrical resistance can be held to a low value.

In the display apparatus according to the present invention, when an FPC is used for the (external circuit) connecting board or the adjusting value setting board, the board is bendable and the display apparatus can therefore be made compact in size. Accordingly, the display apparatus can be mounted in a restricted space. Further, when setting the adjusting value by punching holes, the adjusting value setting work can be accomplished easily because it is easy to punch holes in the FPC.

In the display apparatus according to the present invention, when the panel driving IC and the light source driving IC are disposed relatively close to each other, and when the light source drive timing signals are derived from the panel driving IC, there is no need to route a wiring pattern from the external control circuit directly to the light source driving IC and, hence, the number of long wiring patterns can be reduced. With this configuration, the wiring pattern can be shortened, which serves to reduce the circuit area required for the wiring pattern, etc. and also reduce the wiring resistance. Accordingly, the display apparatus can be reduced in size, and can thus be made to fit into a restricted space.

Further, in the display apparatus according to the present invention, when “panel driving circuit and light source driving circuit” or “panel driving circuit, light source driving circuit, and adjusting section” or “panel driving circuit, light source driving circuit, adjusting section, and setting section” are accommodated on a single IC chip, and when the light source drive timing signals are derived from the panel driving IC, there is no need to route a wiring pattern from the external control circuit directly to the light source driving IC, and hence, the number of long wiring patterns can be reduced. Furthermore, in the display apparatus according to the present invention, when an E²ROM is used, punching or soldering work is not needed, achieving a reduction in production cost while conserving space.

In the display apparatus according to the present invention, the light source drive timing can be perfectly synchronized to the display panel drive timing by using a simple configuration. This is particularly effective when a field-sequential system is employed because optimum driving can be achieved with simple circuitry, cost reduction effects through reductions in the number of components, etc. can be obtained.

### BRIEF DESCRIPTION OF THE DRAWINGS

These and other features and advantages of the present invention will be better understood by reading the following detailed description together with the drawings wherein:

FIG. 1 is a schematic block diagram of a display apparatus according to the present invention;

FIG. 2 is a diagram showing one configuration example of an adjusting value setting section in FIG. 1;

FIG. 3 is a diagram showing one example of light source drive timing signals;

FIG. 4 is a diagram showing another configuration example of the adjusting value setting section;

FIG. 5 is a plan view of a display apparatus according to a first embodiment;

FIG. 6 is a cross-sectional view taken along line C-C of FIG. 5;

FIG. 7 is a rear view of the display apparatus of FIG. 5;

FIG. 8 is a diagram for explaining how a connecting board is folded;

FIG. 9 is a rear plan view of a display apparatus according to a second embodiment;

FIG. 10 is a plan view of a display apparatus according to a third embodiment;

FIG. 11 is a cross-sectional view of the display apparatus taken along line D-D of FIG. 10;

FIG. 12 is a rear view of the display apparatus of FIG. 10;

FIG. 13 is a rear view of a display apparatus according to a fourth embodiment;

FIG. 14(a) is a rear view of a display apparatus according to a fifth embodiment, and FIG. 14(b) is a cross-sectional view taken from FIG. 14(a);

FIG. 15 is a rear view of a display apparatus according to a sixth embodiment;

FIG. 16 is a rear view of a display apparatus according to a seventh embodiment;

FIG. 17 is a rear view of a display apparatus according to an eighth embodiment;

FIG. 18 is a rear view of a display apparatus according to a ninth embodiment;

FIG. 19(a) is a rear view of a display apparatus according to a 10th embodiment, and FIG. 19(b) is a cross-sectional view taken from FIG. 19(a); and

FIG. 20 is a schematic block diagram of a color display apparatus according to the prior art.

### DETAILED DESCRIPTION OF THE PREFERRED EMBODIMENTS

A display apparatus according to the present invention will be described below with reference to the drawings. It will, however, be understood that the present invention is not limited to any specific embodiment described herein or illustrated in the drawings.

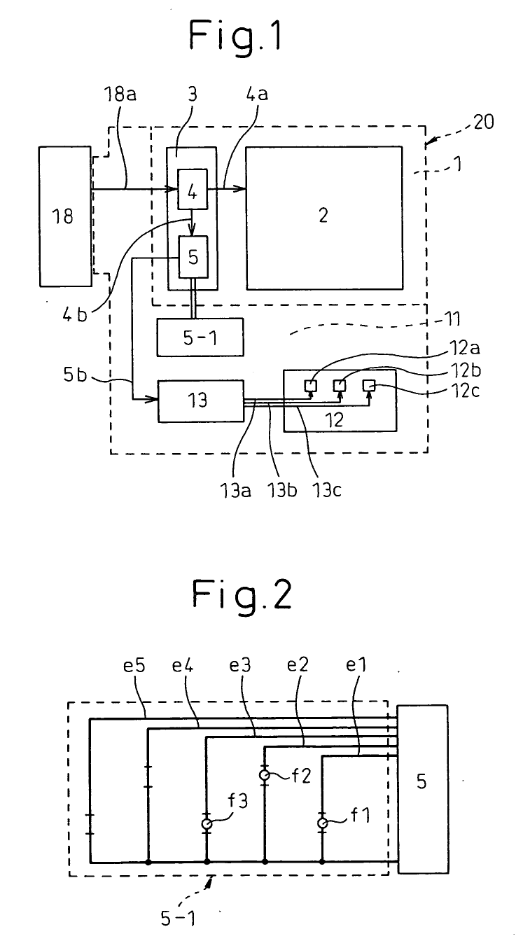

FIG. 1 is a schematic block diagram of the display apparatus according to the present invention.

In FIG. 1, the display apparatus 20 includes a display panel section 1 and a connecting board section 11 shown within dashed lines. The display panel section 1 includes a display panel 2, a panel driving IC (panel driving integrated circuit) 3 for driving the display panel 2, etc. The display panel 2 is a liquid crystal display panel that uses a liquid crystal, and the liquid crystal display panel itself displays only black-and-white images. The panel driving IC 3 as a chip is mounted on the display panel 2.

FIG. 1 shows the flow only of principal signals pertinent to the present invention. Though not shown here, the display apparatus 20 has a structure that uses a light guiding plate, a diffusing plate, a reflecting plate, etc. so that the light from the light source is distributed evenly over the image display area of the display panel 2.

A control circuit 18 includes circuits for controlling the display panel 2 and light source section 12, etc.

The (external circuit) connecting board section 11 is provided to convey a control signal 18a from the external control circuit 18 to the panel driving IC 3. The connecting board section 11 accommodates thereon, in addition to the light source section 12 having three kinds of light sources 12a, 12b, and 12c, a light source driving IC 13 for driving the three kinds of light sources 12a, 12b, and 12c and an adjusting value setting section 5-1 for adjusting light source drive timing signals 13a, 13b, and 13c used to control the flash timings of the three kinds of light sources. The connecting board is constructed, for example, from a flexible printed circuit board (FPC) or the like. The FPC has a flexible structure that can be curved or bent as desired.

The three kinds of light sources 12a, 12b, and 12c are constructed from LEDs that emit light of red color (R), green color (G), and blue color (B), respectively (hereinafter simply referred to as the red LED, the green LED, and the blue LED, respectively). The red, green, and blue LEDs in the light source section 12 sequentially emit in rapid one after another to illuminate the display panel 2 thereby displaying a color image thereon.

The panel driving IC 3 includes a display panel driving circuit 4 and an adjusting circuit 5 for adjusting the pulse widths of the light source drive timing signals 13a, 13b, and 13c. The adjusting circuit 5 is connected to the adjusting value setting section 5-1 which sets pulse width values for the light source drive timing signals 13a, 13b, and 13c. The adjusting value setting section 5-1 is located at a position on the connecting board section 11 near the panel driving IC 3.

The display panel 2 is connected to a power supply line as well as to the display panel driving circuit 4 and the connecting board section 11 on which signal lines for conveying signals to the panel driving IC 3 are formed. The adjusting value setting section 5-1, the light source driving IC 13, and the light source 12 are arranged on the connecting board section 11.

Here, the adjusting value setting section 5-1 may be formed, not on the connecting board section 11, but on a separately provided board constructed from an FPC or the like. Further, a temperature sensor and wiring for the temperature sensor may be accommodated on the connecting board section 11.

The red, green, and blue LEDs used as the light sources 12a, 12b, and 12c differ in the efficiency with which they produce light. For example, chromaticity and brightness are different among the red, green, and blue LEDs, even when they are driven with the same current value. For example, among the currently available LEDs, the brightness of green LEDs is the lowest. Therefore, the red, green, and blue LEDs must be adjusted so that the brightness and chromaticity are balanced between the respective LEDs. The brightness and chromaticity balance settings are made by reference to the white light produced by mixing the colored lights of the red, green, and blue LEDs. As a method for such a white balance correction, the present invention uses the adjusting value setting section 5-1 in conjunction with the adjusting circuit 5 provided within the panel driving IC 3, and adjusts the pulse width of each light source drive timing signal to an optimum value. That is, the pulse widths of the timing signals for the red, green, and blue LEDs are respectively adjusted so that the best white balance can be obtained.

The light source drive timing signals 13a, 13b, and 13c are created by using a signal input to the panel driving IC 3, which means that the light source drive timing signals 13a, 13b, and 13c are synchronized to the panel drive timing signal 4a. In other words, as the light source drive timing signals 13a, 13b, and 13c can be easily synchronized to the panel drive timing signal 4a, the synchronization can be achieved using a simple circuit design and fewer components. This offers a great advantage for a field-sequential (FSC) display apparatus.

As described above, the present invention concerns a display apparatus comprising an illumination device driven by a light source driving IC and a display panel driven by a panel driving IC 3, wherein the light source driving IC drives the illumination device in synchronism with an output from the panel driving IC. Here, the illumination device includes a light source, and the light source is a light-emitting diode (LED). The output from the panel driving IC is a timing signal for the light source driving IC.

Further, the present invention concerns a display apparatus includes an illumination device which includes at least a light source, and a display panel which is illuminated with light from the light source, wherein a timing signal for a light source driving IC for driving the light source is obtained from a panel driving IC which drives the display panel. In this display apparatus, the light source is a light-emitting diode known as LED.

FIG. 2 is a diagram showing one configuration example of the adjusting value setting section 5-1 in FIG. 1.

The adjusting circuit 5 included in the panel driving IC 3 is connected to the adjusting value setting section 5-1 provided outside the panel driving IC 3, and the adjusting value setting section 5-1 has a pattern configuration such as shown within dashed lines in FIG. 2. As shown in FIG. 2, the adjusting value setting section 5-1 has five conductive pattern circuits e1, e2, e3, e4, and e5 connected to the adjusting circuit 5. Reference characters f1, f2, and f3 indicate punched holes by which the conductive lines of the respective circuits are cut off. That is, the conductive line of the pattern circuit e1 is cut off at the position of the punched hole f1. Likewise, the conductive line of the pattern circuit e2 is cut off at the position of the punched hole f2, and the conductive line of the pattern circuit e3 is cut off at the position of the punched hole f3. The conductive lines of the pattern circuits e4 and e5 are not cut off, as there are no punched holes in either circuit.

Here, a conducting circuit provides a logic “1”, while a circuit cut off by a punched hole provides a logic “0”; that is, each pattern circuit can be classified as either a logic “1” circuit or a logic “0” circuit. A different duty ratio value is assigned to a logic “1” circuit than that for a logic “0” circuit.

With the present state of the art of LEDs, the brightness of green LEDs is lower than that of red or blue LEDs, therefore, in the present embodiment, the brightness of the red and blue LEDs is adjusted by reference to the brightness of the green LED. The brightness is adjusted by a pulse-width modulation method. More specifically, the adjustment is made by setting the pulse width of each of the red, green, and blue LED timing signals to an optimum one. In the adjusting value setting section 5-1 shown in FIG. 2, the adjusting value for the green LED timing signal is set using one pattern circuit e5, while the adjusting value for the red LED timing signal is set using two pattern circuits e1 and e2, and likewise, the adjusting value for the blue LED timing signal is set using two pattern circuits e3 and e4.

First, the same duty ratio value (initial value) is given to each of the red, green, and blue LED timing signals. The duty ratio of the green LED timing signal 13b is either the duty ratio determined by the logic “1” (the initially given duty ratio) or the duty ratio determined by the logic “0”, which is provided by the one pattern circuit e5. The duty ratio of the red LED timing signal 13a is either the duty ratio determined by the logic “00” (the initially given duty ratio), the duty ratio determined by the logic “01”, the duty ratio determined by the logic “10”, or the duty ratio determined by the logic “11”, which is provided by the two pattern circuits e1 and e2. Likewise, the duty ratio of the blue LED timing signal 13c is either the duty ratio determined by the logic “00” (the initially given duty ratio), the duty ratio determined by the logic “01”, the duty ratio determined by the logic “10”, or the duty ratio determined by the logic “11”, which is provided by the two pattern circuits e3 and e4. Duty ratio data for the red LED timing signal 13a, the green LED timing signal 13b, and the blue LED timing signal 13c are prestored in a memory provided within the adjusting circuit 5. In this way, using the five conductive pattern circuits e1, e2, e3, e4, and e5 in the adjusting value setting section 5-1, the red LED timing signal 13a, the green LED timing signal 13b, and the blue LED timing signal 13c are adjusted so as to have optimum pulse widths.

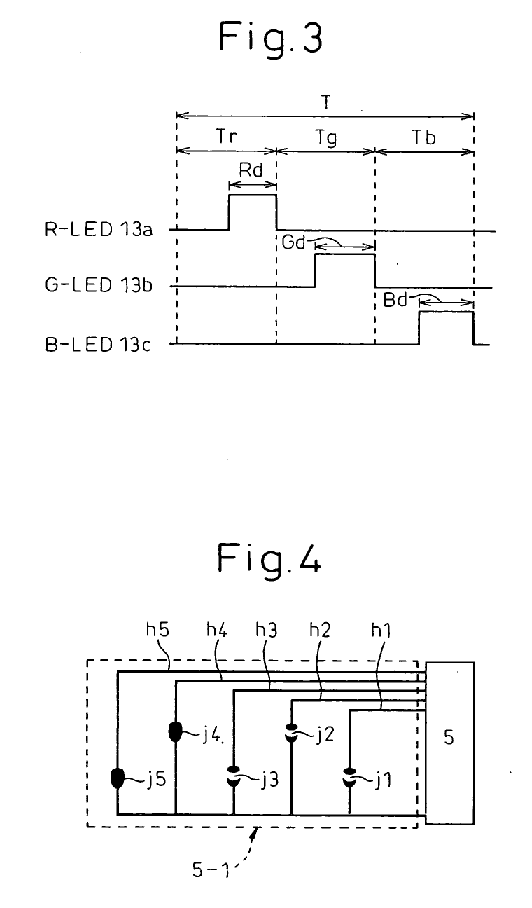

FIG. 3 is a diagram showing one example of light source drive timing signals.

In FIG. 3, the red LED timing signal 13a, the green LED timing signal 13b, and the blue LED timing signal 13c, each adjusted using the adjusting value setting section 5-1, are shown by way of example. In FIG. 3, the duty ratio of the red LED timing signal 13a is Rd/Tr, the duty ratio of the green LED timing signal 13b is Gd/Tg, and the duty ratio of the blue LED timing signal 13c is Bd/Tb. Here, Tr designates the subframe period for turning off and on the red LED, Tg designates the subframe period for turning off and on the green LED, and Tb designates the subframe period for turning off and on the blue LED, while T indicates one frame period. As shown in FIG. 3, the ON time of the green LED is the longest, and the ON times of the red and blue LEDs are each set shorter than the ON time of the green LED. With this adjustment, the chromaticity balance of R, G, and B is set to an optimum one.

Next, a description will be given of how the pattern circuits in the adjusting value setting section 5-1 are punched with holes.

First, the red LED, the green LED, and the blue LED are simultaneously turned on to produce white light from a mixture of the three colors, and the display panel 2 is illuminated with the white light via the light guiding plate, etc. The display panel 2 is driven so as to allow the light to pass through it. Next, using a luminance calorimeter, the chromaticity is measured on the surface of the display panel 2. Then, based on the chromaticity data obtained by the luminance calorimeter, a determination is made as to which pattern circuit or circuits are to be punched from among one pattern circuit e5 for adjusting the green LED timing signal 13b, two pattern circuits e1 and e2 for adjusting the red LED timing signal 13a, and two pattern circuits e3 and e4 for adjusting the blue LED timing signal 13c. If the determination cannot be made at once, the adjusting value is determined for each color.

Operation of the display apparatus 20 shown in FIG. 1 will be described below.

The control signal 18a output from the control circuit 18 provided outside the display apparatus 20 is supplied to the panel driving IC 3 via the connecting board section 11. The panel driving IC 3 creates the panel drive signal 4a based on the received control signal 18a, and supplies it to the display panel 2. The display panel 2 is driven based on the panel drive signal 4a.

A first light source timing signal 4b synchronized to the panel drive signal 4a is supplied from the display panel driving circuit 4 to the adjusting circuit 5. Here, the clock signal contained in the panel drive signal 4a can be used as the first light source timing signal 4b, but instead, use may be made of a clock signal obtained, for example, by dividing the clock signal contained in the panel drive signal 4a. Based on the punched holes formed in the pattern circuits of the adjusting value setting section 5-1, the adjusting circuit 5 creates data for setting the red LED duty ratio (for example, Rd/Tr), the green LED duty ratio (for example, Gd/Tg), and the blue LED duty ratio (for example, Bd/Tb) to optimum values. Further, the adjusting circuit 5 supplies the thus created data indicating the duty ratios of the respective LEDs and the first light source timing signal 4b together as a second light source timing signal 5b to the light source driving IC 13. Based on the data indicating the duty ratios of the respective LEDs, the light source driving IC 13 adjusts and sets the pulse widths of the timing signals for driving the respective LEDs, and generates the red LED timing signal 13a, the green LED timing signal 13b, and the blue LED timing signal 13c (see FIG. 3) synchronized to the received first light source timing signal 4b (clock signal).

Based on the red LED timing signal 13a, the green LED timing signal 13b, and the blue LED timing signal 13c supplied from the light source driving IC 13, the light sources 12a, 12b, and 12c are turned off and on repeatedly by sequentially switching from one to another. In this way, the colored lights from the respective light sources 12a (red LED), 12b (green LED), and 12c (blue LED) exhibit well balanced chromaticity and brightness and, by mixing the colored lights from the respective light sources 12a (red LED), 12b (green LED), and 12c (blue LED), a well balanced white light can be obtained.

As described above, the display apparatus 20 shown in FIG. 1 is constructed so that the second timing signal 5b supplied to the light source driving IC 13 contains the data indicating the duty ratios of the respective LEDs, which is created by the adjusting circuit 5, and the first light source timing signal 4b which is synchronized to the panel drive signal 4a.

In the prior art panel driving IC and light source driving IC, the circuit configuration has been such as that the timing signals are supplied from the separately provided control circuit by way of long wiring patterns separately formed on the external circuit connecting-board. By contrast, in the display apparatus 20 according to the present invention, the number of such long wiring patterns can be reduced. As a result, in the display apparatus 20 according to the present invention, the size of the connecting board section 11 can be reduced, which serves to reduce the overall size of the display apparatus.

Further, in the display apparatus 20, the adjusting value setting section 5-1 is provided at a position on the connecting board section 11 near the panel driving IC 3. This not only facilitates the adjustment of the timing signals, but also has the effect of shortening the length of the wiring patterns to reduce the wiring resistance. Furthermore, in the display apparatus 20, the plurality of conductive pattern circuits (the adjusting value setting section 5-1) are provided on the connecting board section 11, and the pulse widths of the light source drive timing signals are adjusted by punching holes in selected ones of the conductive pattern circuits to cut off the conductive patterns. This greatly facilitates the adjusting work, and makes it possible to set the light source drive timing signals in a short time.

Further, as the connecting board section 11 is made of an FPC and can therefore be bent easily, the display apparatus can be made compact. Because of its compact and small size, the display apparatus can be mounted in a restricted space. Here, the connecting board section 11 is not limited to the one made of an FPC, but a rigid circuit board formed from a multilayer FPC, for example, may be used as the connecting board section 11.

The above example has shown the configuration in which the light source drive timing signals are set by punching holes in selected ones of the plurality of conductive pattern circuits shown in FIG. 2, but the setting method is not limited to this configuration.

FIG. 4 is a diagram showing another configuration example of the adjusting value setting section 5-1 in FIG. 1.

For example, the adjusting value setting section shown in FIG. 4 can be employed instead of the adjusting value setting section shown in FIG. 2. In the adjusting value setting section of FIG. 4, non-conducting portions j1, j2, j3, j4, and j5, at which the conductive lines are cut off, are formed in advance on the plurality of pattern circuits h1, h2, h3, h4, and h5, respectively, and conducting pattern circuits are formed by applying solder to the non-conducting portions of the pattern circuits that need conducting (in FIG. 4, j4 and j5 indicate soldered portions). That is, the adjusting value is set by using the conducting pattern circuits (for example, h4 and h5) in combination with the non-conducting pattern circuits (for example, h1, h2, and h3). The setting method employed in the adjusting value setting section shown in FIG. 4 is the reverse of the method shown in FIG. 2, but in either method, the setting can be made easily.

In FIG. 4, the method of turning a non-conducting portion into a conducting portion is not limited to the soldering method, for example, conduction may be achieved by applying an electrically conductive adhesive. The soldering method is preferred because it can reduce the electrical resistance.

In FIGS. 2 and 4, the pulse width adjusting value for the green LED timing signal is set using one pattern circuit, while the pulse width adjusting value for the red LED timing signal is set using two pattern circuits, and likewise, the pulse width adjusting value for the blue LED timing signal is set using two pattern circuits. That is, the light source drive timing signals have been set using a total of five pattern circuits. However, the number of pattern circuits and the allocation of the pattern circuits are not limited to those shown in the above examples, but can be chosen suitably according to the purpose. In particular, it is preferable to determine the number of pattern circuits and the allocation of the pattern circuits by considering the adjusting accuracy of the chromaticity balance of the colored lights from the red, green, and blue LEDs; as the number of pattern circuits is increased, the adjusting accuracy of the chromaticity balance can be enhanced. In applications where a low adjusting accuracy is allowed, one pattern circuit may be allocated to each of the red LED, green LED, and blue LED timing signals, or two pattern circuits may be allocated only to the green LED timing signal.

The display apparatus of the present invention will be described in detail below with reference to specific embodiments.

### Embodiment 1

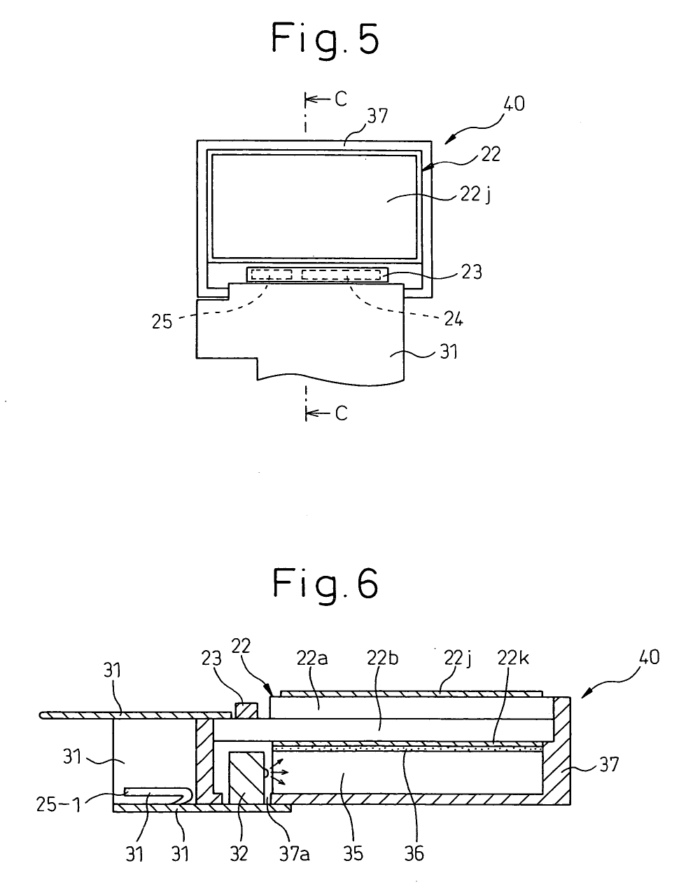

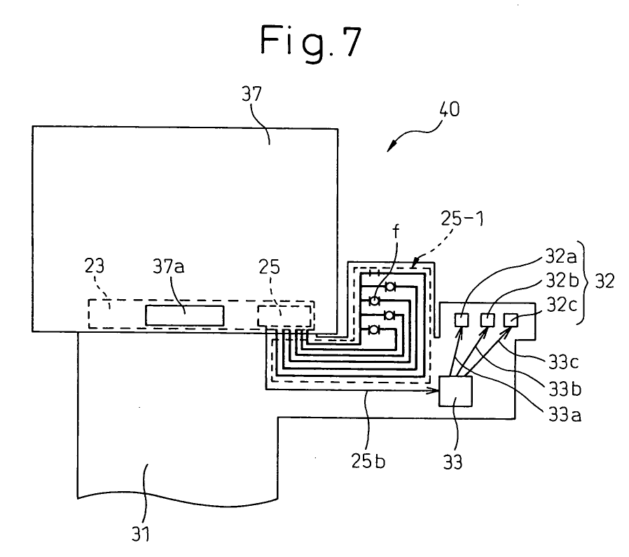

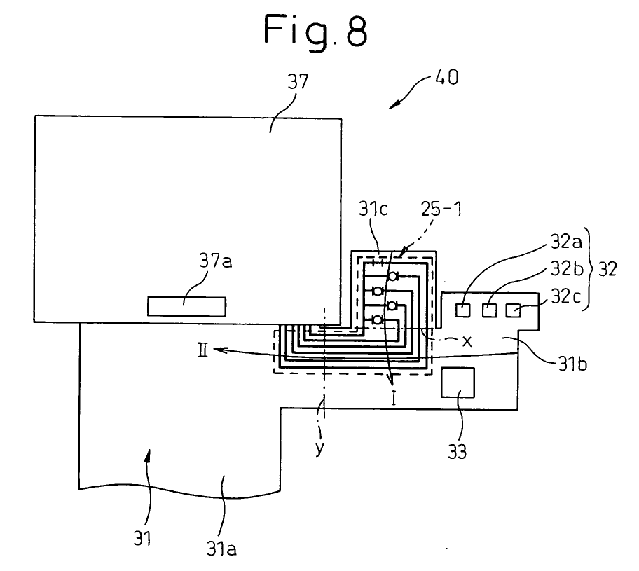

A first embodiment of the present invention will be described with reference to FIGS. 5 to 8. FIG. 5 is a plan view of a display apparatus 40 according to the first embodiment, FIG. 6 is a cross-sectional view of the display apparatus taken along line C-C of FIG. 5, FIG. 7 is a rear view of the display apparatus of FIG. 5, and FIG. 8 is a diagram for explaining how the connecting board is folded.

As shown in FIGS. 5 and 6, the display apparatus 40 includes a display panel 22, an illuminating section consisting of a light source 32, a light guiding plate 35, etc. for illuminating the display panel 22, a supporting frame 37 accommodating the illuminating section and holding the display panel 22 in place, and an FPC 31 connecting between an external control circuit board and the display panel 22 and light source 32.

The display panel 22 is held and supported by the supporting frame 37. A panel driving IC 23 is mounted, by means of an electrically conductive adhesive or the like, on a wiring pattern brought out to an outwardly extended portion of the display panel 22.

The FPC 31 is electrically connected to the panel driving IC 23. Further, the FPC 31 is connected, by means of an electrically conductive adhesive or the like, to wiring electrodes formed on a bottom substrate 22b of the display panel 22. The FPC 31 functions as a board for connecting to an external circuit (not shown). The FPC 31 is connected to the external circuit board accommodating a display panel control circuit, a light source control circuit, etc., and conveys control signals (such as display data) from these control circuits to the panel driving IC. The light source 32, which includes three LEDs 32a, 32b, and 32c for illuminating the display panel 22 and displaying a color image thereon, is mounted on the FPC 31 together with other components such as a light source driving IC 33 for driving the three LEDs 32a, 32b, and 32c. As shown in FIG. 6, a portion of the FPC 31 can be folded behind the supporting frame 37 so that the three LEDs 32a, 32b, and 32c mounted on the FPC 31 are positioned along an end face of the light guiding plate 35.

Inside the supporting frame 37 to which the display panel 22 is held fixed, a light diffusing sheet 36 is disposed under the bottom surface of the panel 22 so as to cover the light guiding plate 35, as shown in FIG. 6. The three LEDs 32a, 32b, and 32c are arranged along one end face of the light guiding plate 35. The three LEDs 32a, 32b, and 32c are located substantially directly below the panel driving IC 23 mounted on the display panel 22.

As shown in FIG. 7, an opening 37a through which the LEDs 32 are inserted is formed in a portion of the bottom of the supporting frame 37. The opening 37a is located substantially directly below the panel driving IC 23 mounted on the display panel 22. The three LEDs 32a, 32b, and 32c are inserted through the opening 37a formed in the bottom of the supporting frame 37 into the interior of the supporting frame 37, and are positioned in close vicinity to the end face of the light guiding plate 35.

The panel driving IC 23 mounted on the display panel 22 incorporates a display panel driving circuit 24 and an adjusting circuit 25 for adjusting the timing signals for the light source 32. The adjusting circuit 25 is connected to an adjusting value setting section 25-1 which is disposed outside the panel driving IC 23 and by which the timing signals for the three LEDs 32a, 32b, and 32c are adjusted to optimum pulse widths. The adjusting value setting section 25-1 includes pattern circuits shown within dashed lines in FIG. 7, and is located at a position on the FPC 31 near the panel driving IC 23.

As shown in FIG. 6, the display panel 22 is constructed by arranging top and bottom substrates 22a and 22b opposite each other with a few-micrometer gap provided therebetween (for example, a 4.7-μm gap in the case of an FSC type TFT panel and a 5-μm gap in the case of a TFT panel other than the FSC type) and by filling a liquid crystal as an electro-optical material into the gap. Polarizers 22j and 22k are provided on the upper and lower surfaces of the top and bottom substrates 22a and 22b of the display panel 22. The top and bottom substrates 22a and 22b are each formed from a transparent substrate made of transparent glass or the like. A transparent electrode made of ITO and an alignment film covering the transparent electrode are formed on the liquid crystal side of the top substrate 22a. Likewise, a transparent electrode made of ITO and an alignment film covering the transparent electrode are formed on the liquid crystal side of the bottom substrate 22b. The transparent electrode formed on the bottom substrate 22b has a plurality of electrode elements each rectangular in shape and arranged in a matrix array, and a TFT device is provided for each electrode element. Each electrode element provided with a TFT device forms one pixel, and an image is formed with a plurality of such pixels. The transparent electrode formed on the top substrate 22a is a single flat electrode, but need not be formed over the entire surface and may be formed in the form of an electrode pattern. Alternatively, TFT devices may be formed on the top substrate 22a, and the transparent electrode on the bottom substrate 22b may be formed as a single flat electrode.

TN liquid crystal having a low viscosity has been used as the liquid crystal above, but other liquid crystal material such as STN liquid crystal or ferroelectric liquid crystal may be used. In the present embodiment, the liquid crystal is set so as to transmit light in the absence of an applied voltage but not transmit light when a voltage is applied (normally white mode). However, when using STN liquid crystal, the display should be set as a normally black display. The present invention is applicable to either display mode, the normally white mode or the normally black mode.

The panel driving IC 23 is glued to an extended portion of the bottom substrate 22b by using an electrically conductive adhesive such as an anisotropic conductive adhesive (an insulating adhesive mixed with conductive particles) for connection to the wiring electrodes formed on the bottom substrate 22b. The panel driving IC 23 incorporates the display panel driving circuit 24 and the adjusting circuit 25 for adjusting the timing signals for the three LEDs 32a, 32b, and 32c. The adjusting circuit 25 is provided to adjust the white balance produced by mixing the colored lights from the light source 32 having the red, green, and blue LEDs. The panel drive signal output from the display panel driving circuit 24 is supplied to the display panel 22 to drive the display panel 22. At the same time, the display panel driving circuit 24 outputs a timing signal (for example, a clock signal) to the adjusting circuit 25. The adjusting circuit 25 supplies to the light source driving IC 33 mounted on the FPC 31 a signal 25b that contains the timing signal and the adjusting value data for optimum pulse widths set by the pulse width adjusting value setting section 25-1 (see FIGS. 6 and 7) provided on the FPC 31.

FIG. 7 is a developed view of the FPC 31, showing the reverse side thereof. The adjusting value setting section 25-1 shown within the dashed lines is located at a position on the FPC 31 near the adjusting circuit 25 incorporated in the panel driving IC 23. The light source driving IC 33 and the three LEDs 32a, 32b, and 32c are mounted in the vicinity of the adjusting value setting section 25-1. A pattern circuit is formed between the light source driving IC 33 and the adjusting circuit 25 so that the signal 25b, which contains the timing signal input to the adjusting circuit 25 and the adjusting value data for optimum pulse widths set by the pulse width adjusting value setting section 25-1 provided on the FPC 31, is supplied from the adjusting circuit 25 to the light source driving IC 33. Further, pattern circuits are formed between the light source driving IC 33 and the three individual LEDs 32a, 32b, and 32c so that light source drive signals 33a, 33b, and 33c are supplied from the light source driving IC 33 to the three LEDs 32a, 32b, and 32c, respectively.

The light source 32 includes the red (R) LED 32a, the green (G) LED 32b, and the blue (B) LED 32c. LEDs are commercially available either in a single package type in which the red, green, and blue LEDs are each encased in a separate package or in the so-called three-in-one package type in which the red, green, and blue LEDs are encased in one package, and either type can be used in the present embodiment.

The adjusting value setting section 25-1 includes five pattern circuits, and has the same configuration as the pattern circuits 5-1 shown in FIG. 2. Of the five pattern circuits, one is used for the adjustment of the timing signal for the green LED 32b, two for the adjustment of the timing signal for the red LED 32a, and the remaining two for the adjustment of the timing signal for the blue LED 32c. The adjusting values for the timing signals for the red, green, and blue LEDs 32a, 32b, and 32c are set by punching holes f in the selected conductive pattern circuits. The method of setting the adjusting values for the timing signals for the red, green, and blue LEDs 32a, 32b, and 32c according to the first embodiment is the same as the method described with reference to FIG. 2. In the first embodiment, the adjusting values have been set so that the timing signal for the green LED 32b has a duty ratio of about 20%, the timing signal for the red LED 32a has a duty ratio of about 10%, and the timing signal for the blue LED 32c has a duty ratio of about 10%. Here, the duty ratio defines the emitting duration of each LED; for example, when the emitting duration of the green LED 32b is about 3.5 ms, then the emitting duration of the red LED 32a is about 1.75 ms, and the emitting duration of the blue LED 32c is also about 1.75 ms.

In the first embodiment, the supporting frame 37 is formed by injection-molding a white polycarbonate resin or the like. The three LEDs 32a, 32b, and 32c, the light guiding plate 35, etc. are provided inside the supporting frame 37. The interior surface of the supporting frame 37 has a glossy finish so that the light emitted from the LEDs can be efficiently reflected. Further, the supporting frame 37 has a rectangular housing recess in which the three LEDs 32a, 32b, and 32c and the light guiding plate 35 are provided. The upper surface of the light guiding plate 35 is covered with the light diffusing sheet 36 above which the display panel 22 is placed and fixed to the supporting frame 37. The opening 37a is formed in an edge portion of the bottom of the supporting frame 37 so that the three LEDs can be inserted from the outside. If necessary, a prism sheet can be provided between the light diffusing sheet 36 and the display panel 22.

The light guiding plate 35 is formed from a transparent acrylic resin or the like, and causes the light emitted from the LEDs and incident on its end face to be distributed to the display panel 22. A reflecting means is provided on the bottom surface of the light guiding plate 35 to ensure that the incident light is distributed evenly over the entire area of the display panel.

The FPC 31 is folded so that the three LEDs 32a, 32b, and 32c mounted thereon are inserted through the opening 37a of the supporting frame 37 into the interior of the supporting frame 37 and are positioned in close vicinity to the end face of the light guiding plate 35. The FPC 31 thus folded is glued to the rear side of the supporting frame 37 by a double-side-adhesive sheet and fixed in place.

The FPC 31 is folded as shown in FIG. 8. First, a protruding branch portion 31c of the FPC 31 on which the adjusting value setting section 25-1 is formed is folded in the direction of I at a position x indicated by a semi-dashed line. Next, a protruding branch portion 31b of the FPC 31 on which the three LEDs 32a, 32b, and 32c are mounted is folded in the direction of II at a position y indicated by a semi-dashed line. At this time, the three LEDs 32a, 32b, and 32c are inserted in the opening 37a of the supporting frame 37. In this way, the three LEDs 32a, 32b, and 32c are positioned along the end face of the light guiding plate 35.

When the FPC 31 is folded as described above, the protruding branch portion 31c, on which the adjusting value setting section 25-1 is formed, is sandwiched between the protruding branch portion 31b on which the three LEDs 32a, 32b, and 32c are mounted and the main conductive pattern portion 31a of the FPC 31 which extends toward the control circuit (not shown). In this way, the protruding branch portion 31c is folded out of the way and held fixed in position. Further, the FPC 31 itself can also be made compact to reduce the space it occupies. This makes it possible to mount the display apparatus in a restricted space.

Next, a description will be given of how the adjusting values are set by the adjusting value setting section 25-1.

First, before setting the adjusting values, the FPC 31 is folded in the directions of I and II. Next, with the three LEDs 32a, 32b, and 32c positioned along the end face of the light guiding plate 25, the FPC 31 is temporarily fastened. The temporary fastening here means that the FPC 31 is fastened so that it can be easily unfastened later, and this is accomplished by using a double-side-adhesive tape or a light-shielding adhesive tape. Next, the three LEDs 32a, 32b, and 32c are simultaneously turned on, and the display panel 22 is illuminated with the white light produced by mixing the three colors. Then, the saturation of the white light emerging from the display panel 22 is measured using a luminance calorimeter. Next, based on the saturation of the white light thus measured, a determination is made as to which of the five pattern circuits in the adjusting value setting section 25-1 is to be punched with a hole. Next, the FPC 31 is unfastened to disengage the three LEDs 32a, 32b, and 32c from the supporting frame 37, and the FPC 31 is unfolded in directions opposite to I and II. Next, each selected pattern circuit is punched with a hole (punching step). Finally, the FPC 31 is again folded in the directions of I and II and, with the three LEDs 32a, 32b, and 32c positioned along the end face of the light guiding plate 25, the FPC 31 is permanently fastened in place. The permanent fastening is accomplished by using a double-side-adhesive sheet or the like, as earlier described. The final assembly with the adjusting values properly set is thus completed.

In an alternative method for setting the adjusting values, the characteristics of the three LEDs 32a, 32b, and 32c are measured in advance, and the selected pattern circuits in the adjusting value setting section 25-1 are punched with holes in accordance with the measured characteristics, after which the FPC 31 is folded in the directions of I and II. This setting method has the advantage of being able to fabricate the apparatus at low cost.

The display apparatus 40 according to the first embodiment uses the liquid crystal display panel 22, and the liquid crystal display panel 22 itself displays a black-and-white image. However, as the black-and-white pixels of the liquid crystal display panel are driven while emitting the red, green, and blue LEDs 32a, 32b, and 32c by sequentially switching from one to another at a fast rate, the display apparatus 40 can produce a color image for display. That is, the display apparatus 40 is a field-sequential type liquid crystal display apparatus. The display apparatus 40 can produce color images by mixing two colors or three colors.

The display panel driving circuit 24 outputs a timing signal (for example, a clock signal) to the adjusting circuit 25. The adjusting circuit 25 supplies to the light source driving IC 33 mounted on the FPC 31 the signal 25b that contains the timing signal and the adjusting value data for optimum pulse widths set by the pulse width adjusting value setting section 25-1 provided on the FPC 31. The timing signals for the red, green, and blue LEDs 32a, 32b, and 32c are output from the light source driving IC 33. The brightness balance of the R, G, and B colors is thus adjusted, and white light of good chromaticity or brightness can be obtained. Here, the emitting timing of each of the red, green, and blue LEDs may be adjusted by the adjustment of the adjusting value setting section 25-1.

In the first embodiment, the adjustment of the pulse width of each light source drive timing signal is made by the adjusting circuit 25. The adjusting circuit 25, which is contained in the panel driving IC 23, is configured to derive a timing signal (clock signal) from the display panel driving circuit 24 within the same panel driving IC 23. Since there is no need to separately receive a timing signal from an external circuit, the number of wiring patterns can be reduced. This has the effect of reducing the size of the (external circuit) connecting board constructed from the FPC.

The setting for the adjustment of the pulse width of each flash timing signal in the adjusting circuit 25 is made by using the adjusting value setting section 25-1 provided outside the panel driving IC 23. Accordingly, the adjusting value can be set in a simple and easy manner. The adjusting value setting section 25-1 includes five conductive pattern circuits, and holes are punched in selected ones of the pattern circuits. As the five pattern circuits are formed on the FPC made of a flexible material, holes can be easily punched, and the adjusting value can be set in a short time. The method of setting the adjusting value is not limited to punching holes, but the soldering method previously shown in FIG. 4, for example, may be employed.

In the first embodiment, as the adjusting value setting section 25-1 is provided at a position on the FPC 31 near the panel driving IC 23, the pattern circuits can be formed in a compact space.

In the first embodiment, the FPC is used for connection to the external circuit. The FPC, which is flexible and easily bendable, can be folded to reduce the space it occupies. The effect of this is that the display apparatus can be mounted in a restricted space.

In the first embodiment, the light source drive timing signals have been set using a total of five pattern circuits. However, the number of pattern circuits and the allocation of the pattern circuits are not limited to those shown in the above example, but can be chosen suitably according to the purpose. In particular, it is preferable to determine the number of pattern circuits and the allocation of the pattern circuits by considering the adjusting accuracy of the chromaticity balance of the colored lights from the red, green, and blue LEDs; as the number of pattern circuits is increased, the adjusting accuracy of the chromaticity balance can be enhanced. In applications where a low adjusting accuracy is allowed, one pattern circuit may be allocated to each of the red LED, green LED, and blue LED timing signals, or two pattern circuits may be allocated only to the green LED timing signal.

### Embodiment 2

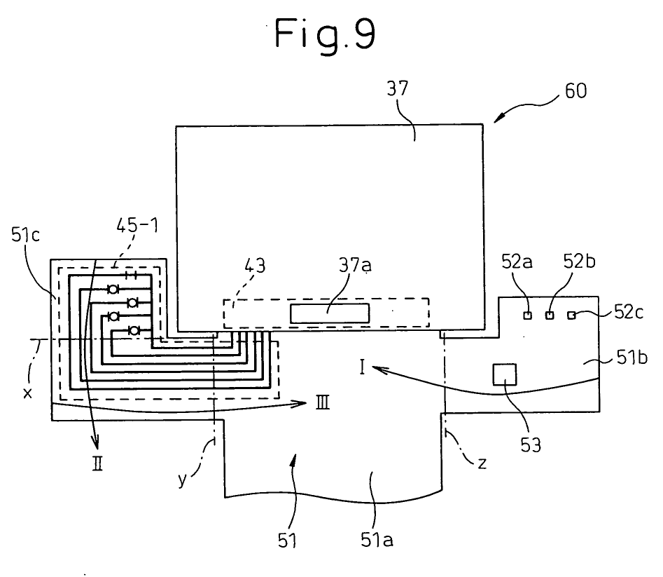

A second embodiment of the present invention will be described with reference to FIG. 9. FIG. 9 is a rear view of a display apparatus 60 according to the second embodiment.

In FIG. 9, a developed view of an FPC 51 is shown. In the display apparatus 60, as in the display apparatus 40 according to the first embodiment, the light guiding plate, light diffusing sheet, display panel, etc. are accommodated and fixed in place in the rectangular housing recess formed in the supporting frame 37. The supporting frame 37 is identical in construction to that used in the first embodiment, and is therefore designated by the same reference numeral. The light guiding plate and the light diffusing sheet are also identical in construction to those used in the first embodiment. The display panel is a liquid crystal display panel identical in construction to that of the first embodiment. Further, as in the first embodiment, a panel driving IC 43 for driving the display panel incorporates a display panel driving circuit and an adjusting circuit for adjusting the light source drive timing signals. The adjusting circuit is connected to an adjusting value setting section 45-1, provided outside the panel driving IC 43, for setting the pulse width adjusting values for the light source drive timing signals.

The display apparatus 60 differs from the display apparatus 40 of the first embodiment only in the way in which the circuits are arranged. Therefore, the FPC 51 connected to the panel driving IC 43 greatly differs in shape and configuration from the FPC 31 used in the display apparatus 40 of the first embodiment.

The area of the FPC 51 is roughly divided into a main portion 51a on which many conductive patterns are formed extending toward the external control circuit, a protruding branch portion 51b which protrudes from the main portion 51b toward the right-hand side of the figure, and on which a light source driving IC 53, a red LED 52a, a green LED 52b, and a blue LED 52c are mounted, and a protruding branch portion 51c which protrudes from the main portion 51b toward the left-hand side of the figure, and on which the adjusting value setting section 45-1 is formed. The adjusting value setting section 45-1 formed on the protruding branch portion 51c includes five pattern circuits, and has the same configuration as the adjusting value setting configuration used in the foregoing first embodiment. Though not shown here, the light source driving IC 53 and the panel driving IC 43 are connected by conductive patterns, and the light source driving IC 53 and the red, green, and blue LEDs 52a, 52b, and 52c are also connected by conductive patterns.

The display panel driving circuit outputs a timing signal (for example, a clock signal) to the adjusting circuit. The adjusting circuit supplies to the light source driving IC 53 mounted on the FPC 51 a signal that contains the timing signal and the adjusting value data for optimum pulse widths set by the pulse width adjusting value setting section 45-1 provided on the FPC 51. The red, green, and blue LEDs 52a, 52b, and 52c emite, each for a predermined pulse duration, by sequentially switching from one to another in accordance with the light source drive timing signals supplied from the light source driving IC 53. The brightness balance of the R, G, and B colors is thus adjusted, and white light of good chromaticity or brightness can be obtained. Here, the flash timing of each of the red, green, and blue LEDs may be adjusted by the adjustment of the adjusting value setting section 45-1.

Next, a description will be given of how the adjusting values are set by the adjusting value setting section 45-1.

First, the protruding branch portion 51b of the FPC 51 is folded in the direction of I at a position indicated by a semi-dashed line z. At the same time, the red, green, and blue LEDs 52a, 52b, and 52c are inserted through the opening 37a of the supporting frame 37 and positioned along the end face of the light guiding plate mounted inside the supporting frame 37. Next, the protruding branch portion 51b is fixed to the reverse side of the supporting frame 37 by using a double-side-adhesive sheet or the like. The red, green, and blue LEDs 52a, 52b, and 52c are thus fixed in position along the end face of the light guiding plate. Next, the red, green, and blue LEDs 52a, 52b, and 52c are simultaneously turned on, and the display panel is illuminated with the white light produced by mixing the three colors. Then, the saturation of the white light emerging from the display panel is measured using a luminance colorimeter. Next, based on the saturation of the white light thus measured, a determination is made as to which of the five pattern circuits in the adjusting value setting section 45-1 is to be punched with a hole. Next, each selected pattern circuit is punched with a hole. In this way, the adjusting values are determined for the pulse widths of the timing signals for the red, green, and blue LEDs 52a, 52b, and 52c. Next, the protruding branch portion 51c of the FPC 51, on which the adjusting value setting section 45-1 is formed, is folded in the direction of II at a position indicated by a semi-dashed line x. The thus folded protruding branch portion 51c is further folded, this time in the direction of III at a position indicated by a semi-dashed line y. At this time, the folded protruding branch portion 51c is inserted between the main portion 51a and the protruding branch portion 51b folded in the direction of I. In this way, the protruding branch portion 51c on which the adjusting value setting section 45-1 is formed is held in the condition that it is not easy to move from its position, and the entire FPC 51 is thus held in a folded condition.

With the above configuration, the selected pattern circuits in the adjusting value setting section 45-1 can be punched with holes while holding the red, green, and blue LEDs 52a, 52b, and 52c fixed to the supporting frame 37. Then, immediately after setting the adjusting values by punching holes, the FPC 51 can be folded up. Compared with the foregoing first embodiment, the adjusting value setting work is greatly facilitated because there is no need to disengage the red, green, and blue LEDs 52a, 52b, and 52c from the supporting frame after measuring the chromaticity. Furthermore, as the settings can be made while viewing the luminance colorimeter, the adjusting value setting accuracy can be enhanced.

In an alternative method for setting the adjusting values, the characteristics of the red, green, and blue LEDs 52a, 52b, and 52c are measured in advance, and the selected pattern circuits in the adjusting value setting section 45-1 are punched with holes in accordance with the measured characteristics, after which the FPC 51 is folded in the directions of I, II, and III. This setting method has the advantage of being able to fabricate the apparatus at low cost.

It will be appreciated that various effects identical to those obtained in the first embodiment can also be obtained in the second embodiment.

### Embodiment 3

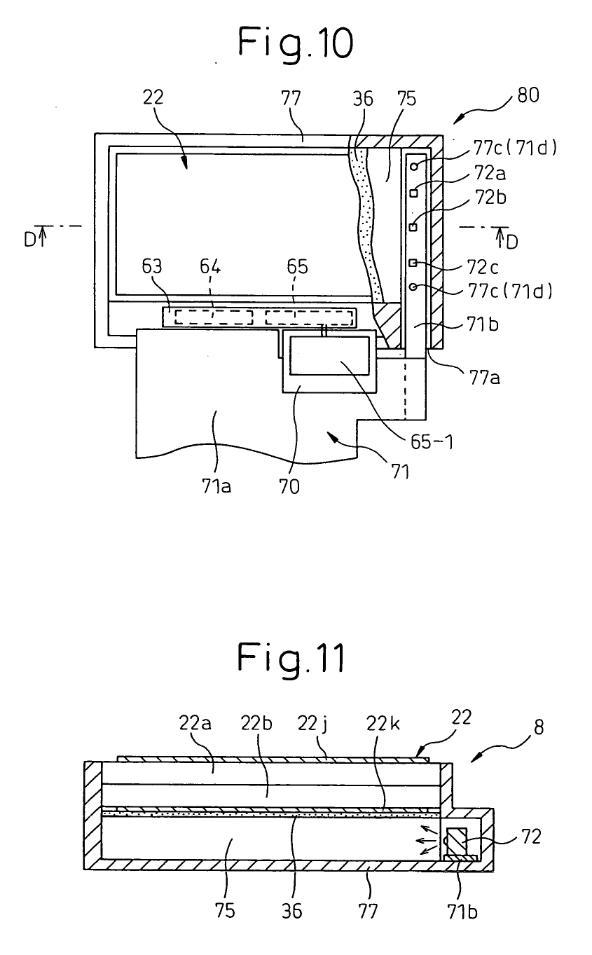

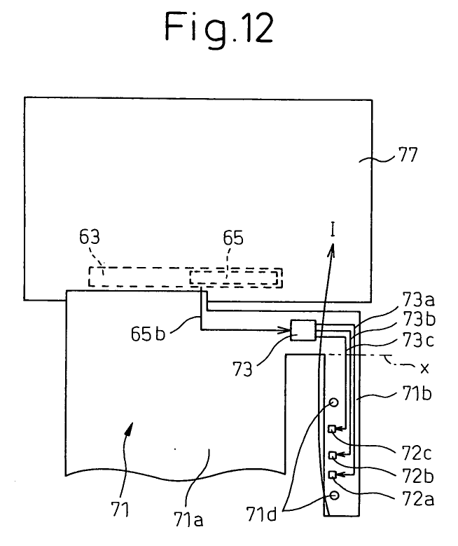

A third embodiment of the present invention will be described with reference to FIGS. 10 to 12. FIG. 10 is a plan view of a display apparatus 80 according to the third embodiment, FIG. 11 is a cross-sectional view of the display apparatus taken along line D-D of FIG. 10, and FIG. 12 is a rear view of the display apparatus of FIG. 10.

In the display apparatus 80 according to the third embodiment, a light guiding plate 75, light diffusing sheet 36, and display panel 22 are accommodated and fixed in place in a recess formed in a supporting frame 77. The display panel 22 is a liquid crystal display panel which is identical in construction to that of the first embodiment. The light diffusing sheet 36 is also identical in construction to that used in the first embodiment. The structure of the light guiding plate 75 of the third embodiment is such that the light emitted from the red, green, and blue LEDs 72a, 72b, and 72c is introduced through the right side edge and distributed to the display panel 22. A panel driving IC 63 is connected, by means of an electrically conductive adhesive, to wiring electrodes formed on an extended portion of the bottom substrate 22b of the display panel 22. A first FPC 71 and a second FPC 70 are electrically connected by an anisotropic conductive adhesive to the panel driving IC 63 on the extended portion of the bottom substrate 22b. The first FPC 71 functions as an (external circuit) connecting board for connecting to an external control circuit, and conductive patterns for conveying control signals output from the external control circuit are accommodated on the first FPC 71 together with such components as a light source driving IC and red, green, and blue LEDs 72a, 72b, and 72c. On the other hand, the second FPC accommodates an adjusting value setting section 65-1 for an adjusting circuit 65 described hereinafter, and functions as an adjusting value setting board.

The panel driving IC 63 incorporates a display panel driving circuit 64 for driving the display panel 22 and the adjusting circuit 65 for adjusting the pulse width of each light source drive timing signal. The adjusting circuit 65 is connected to the adjusting value setting section 65-1, provided outside the panel driving IC 63, for setting the pulse width adjusting values. The adjusting value setting section 65-1 is provided on the second FPC 70. The configuration of the adjusting value setting section 65-1 is the same as that of the adjusting value setting section 25-1 of the first embodiment. That is, the adjusting value setting section 65-1 comprises five conductive patterns, and sets the adjusting values by punching holes in designated pattern circuits.

As shown in FIG. 12, the first FPC 71 includes a main portion 71a which is connected to the external control circuit (not shown), and on which the plurality of conductive patterns for conveying the control signals, etc. are formed, and a protruding branch portion 71b which protrudes from the main portion 71a toward the right-hand side of the figure. The light source driving IC 73, the red, green, and blue LEDs 72a, 72b, and 72c, etc. are mounted on the protruding branch portion 71b. The protruding branch portion 71b is folded in the direction of I at a position indicated by a semi-dashed line x. At this time, the portion on which the red, green, and blue LEDs 72a, 72b, and 72c are mounted is inserted through the opening 77a of the supporting frame 77, and the red, green, and blue LEDs 72a, 72b, and 72c are thus positioned along the end face of the light guiding plate 75. The protruding branch portion 71b is provided with holes 71d at two positions, and the protruding branch portion 71b is secured to the supporting frame 77 by causing the holes 71d to firmly engage with two protrusions 77c formed on the bottom of the supporting frame 77. With the protruding branch portion 71b thus secured to the supporting frame 77, the red, green, and blue LEDs 72a, 72b, and 72c are held fixed in position along the end face of the light guiding plate 75. However, the structure for fixing the red, green, and blue LEDs 72a, 72b, and 72c in position is not limited to the above structure, but the branch portion 71b of the FPC 71 may be fixed to the supporting frame 77, for example, by using a double-side-adhesive tape.

The display panel driving circuit 64 outputs a timing signal (for example, a clock signal) to the adjusting circuit 65. The adjusting circuit 65 supplies to the light source driving IC 73 mounted on the FPC 71 a signal 65b that contains the timing signal and the adjusting value data for optimum pulse widths set by the pulse width adjusting value setting section 65-1 provided on the FPC 70. The red, green, and blue LEDs 72a, 72b, and 72c emit, each for a predetermined pulse duration, by sequentially switching from one to another in accordance with the light source drive timing signals supplied from the light source driving IC 73. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 65-1.

In the present embodiment, the adjusting value setting section 65-1 is formed on the dedicated second FPC 70. Accordingly, the adjusting value setting work can be performed after the red, green, and blue LEDs 72a, 72b, and 72c have been assembled into position, and the setting work can be completed in a short time.

While the present embodiment requires the use of two separate FPCs, the first FPC 71 and the second FPC 70, the width of the FPC material used can be reduced because the amount of protrusion of the protruding branch portion 71b protruding from the main portion 71a is small. Accordingly, the amount of material to be discarded when forming the FPC can be reduced. T-his has the effect of reducing the material cost.

In the present embodiment, the first FPC 71 and the second FPC 70 overlap each other, but since the FPC need only be folded at one position, the damage to the conductive patterns due to the folding can be minimized.

In the present embodiment, as the light source is driven by using the timing signal (clock signal) input to the panel driving IC 63, as in the first and other embodiments, the number of conductive patterns to be brought out of the panel driving IC 63 can be reduced. Further, in the present embodiment, the width of the FPC to be connected to the panel driving IC 63 can be reduced, which offers the effect of reducing the size and the material cost.

In the present embodiment, as the adjusting value setting section for adjusting the light source drive timing signals is provided on the dedicated FPC, greater freedom is allowed in designing the pattern circuits, and the circuit pattern length, etc. can be reduced.

### Embodiment 4

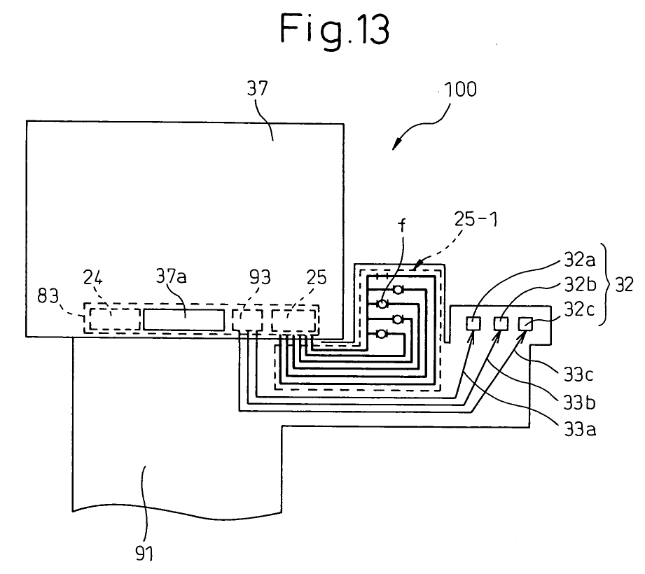

A fourth embodiment of the present invention will be described with reference to FIG. 13. FIG. 13 is a rear view of a display apparatus 100 according to the fourth embodiment.

The display apparatus 100 of the fourth embodiment is a modification of the display apparatus 40 of the first embodiment. Accordingly, in FIG. 13, components identical to those in the display apparatus 40 shown in FIG. 7 are designated by the same reference numerals. The display apparatus 100 differs from the display apparatus 40 in that the circuitry incorporated in the light source driving IC 33 of the display apparatus 40 is incorporated as a light source driving circuit 93 in the panel driving IC 83. That is, in the present embodiment, the panel driving IC 83 contains the display panel driving circuit 24, the light source driving circuit 93, and the adjusting circuit 25. Accordingly, the timing signal 33a for the red LED 32a, the timing signal 33b for the green LED 32b, and the timing signal 33c for the blue LED 32c are output from the panel driving IC 83. The configuration of the present embodiment, i.e., the display panel 22, the display panel driving circuit 24, the adjusting circuit 25, the adjusting value setting section 25-1, the red LED 32a, the green LED 32b, the blue LED 32c, the supporting frame 37, etc. are the same as those in the display apparatus 40, and the description of such components will not be repeated here. Further, the adjusting value setting method in the adjusting value setting section 25-1 is the same as that employed for the display apparatus 40, and therefore, the description thereof will not be repeated here. Furthermore, the method of folding the FPC 91 and the method of positioning the red, green, and blue LEDs 32a, 32b, and 32c are the same as those employed for the display apparatus 40, and therefore, the description thereof will not be repeated.

In the display apparatus 100 of the fourth embodiment, the display panel driving circuit 24 outputs a timing signal (for example, a clock signal) to the adjusting circuit 25. The adjusting circuit 25 supplies to the light source driving circuit 93 within the same panel driving IC 83 a signal that contains the timing signal and the adjusting value data for optimum pulse widths set by the pulse width adjusting value setting section 25-1 provided on the FPC 91. The red, green, and blue LEDs 32a, 32b, and 32c emit, each for a predetermined pulse duration, by sequentially switching from one to another in accordance with the light source drive timing signals 33a, 33b, and 33c supplied from the light source driving circuit 93 contained in the panel driving IC 83. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 25-1.

In the present embodiment, as the light source is driven by using the timing signal (clock signal) input to the panel driving IC 83, as in the first and other embodiments, the number of conductive patterns to be brought out of the panel driving IC 83 can be reduced. Furthermore, in the present embodiment, as the circuitry incorporated in the light source driving IC 33 mounted as an independent component in the first embodiment is incorporated in the panel driving IC 83, the number of conductive patterns to be brought out of the panel driving IC 83 can be further reduced.

### Embodiment 5

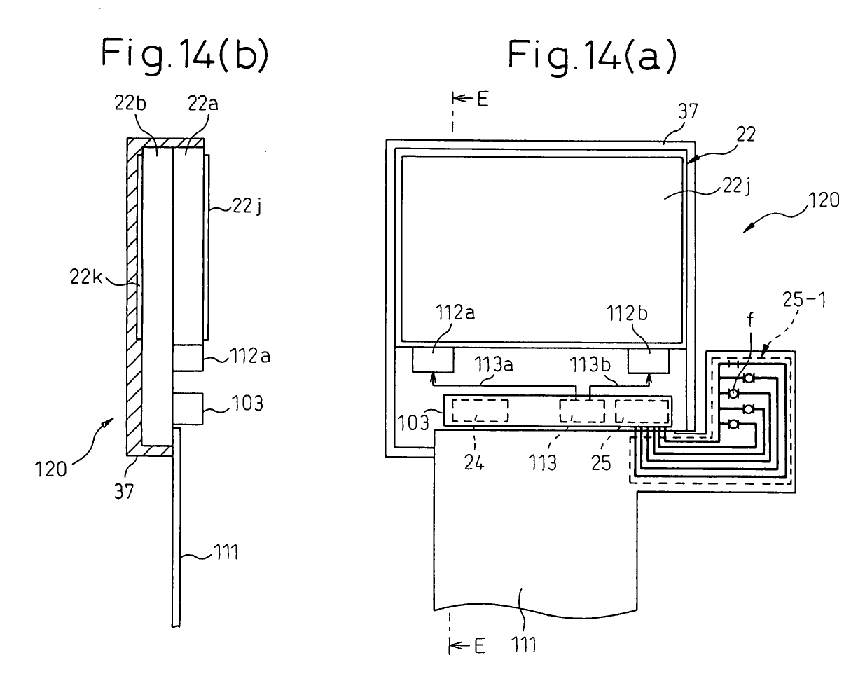

A fifth embodiment of the present invention will be described with reference to FIG. 14. FIG. 14(a) is a plan view of a display apparatus 120 according to the fifth embodiment, and FIG. 14(b) is a cross-sectional view taken along line E-E of FIG. 14(a).

The display apparatus 120 of the fifth embodiment is a modification of the display apparatus 40 of the first embodiment. Accordingly, in FIG. 14, components identical to those in the display apparatus 40 shown in FIG. 7 are designated by the same reference numerals. The display apparatus 120 differs from the display apparatus 40 in that the circuitry incorporated in the light source driving IC 33 of the display apparatus 40 is incorporated as a light source driving circuit 113 in the panel driving IC 103, and in that the light source is mounted on the display panel 22.

That is, in the present embodiment, the panel driving IC 103 contains the display panel driving circuit 24, the light source driving circuit 113, and the adjusting circuit 25. Accordingly, the light source drive timing signals 113a and 113b are output from the panel driving IC 103 to the respective light sources 112a and 112b.

In the present embodiment, the light sources 112a and 112b are mounted on an extended portion of the bottom substrate 22b extending outwardly beyond a side edge of the top substrate 22a of the display panel 22, and are positioned in close proximity to the edge face of the top substrate 22a. The light sources 112a and 112b are each a so-called three-in-one type LED containing a red LED, a green LED, and a blue LED in one package. That is, in the present embodiment, two sets of red, green, and blue LEDs respectively corresponding to the red, green, and blue LEDs 32a, 32b, and 32c in the first embodiment are mounted on the display panel 22, not on the FPC. It is also understood that the light source drive timing signals 113a and 113b respectively contain the same timing signals for the red, green, and blue LEDs (see FIG. 3).

The other configuration of the present embodiment, for example, the display panel 22, the display panel driving circuit 24, the adjusting circuit 25, the adjusting value setting section 25-1, the supporting frame 37, etc. are the same as those in the display apparatus 40, and the description of such components will not be repeated here. Further, the adjusting value setting method in the adjusting value setting section 25-1 is the same as that employed for the display apparatus 40, and therefore, the description thereof will not be repeated.

In the display apparatus 120 of the fifth embodiment, the display panel driving circuit 24 outputs a timing signal (for example, a clock signal) to the adjusting circuit 25. The adjusting circuit 25 supplies to the light source driving circuit 113 within the same panel driving IC 103 a signal that contains the timing signal and the adjusting value data for optimum pulse widths set by the pulse width adjusting value setting section 25-1 provided on the FPC 111. The red, green, and blue LEDs contained in the light sources 112a and 112b emit, each for a predetermined pulse duration, by sequentially switching from one to another in accordance with the light source drive timing signals 113a and 113b supplied from the light source driving circuit 113 contained in the panel driving IC 103. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 25-1.

In the present embodiment, as the light source is driven by using the timing signal (clock signal) input to the panel driving IC 103, as in the first and other embodiments, the number of conductive patterns to be brought out of the panel driving IC 103 can be reduced. Furthermore, in the present embodiment, as the circuitry incorporated in the light source driving IC 33 mounted as an independent component in the first embodiment is incorporated in the panel driving IC 103, the number of conductive patterns to be brought out of the panel driving IC 103 can be further reduced. Further, in the present embodiment, as the light source mounted on the FPC in the first embodiment is mounted on the display panel at a position near the panel driving IC 103, the display apparatus can be made compact in size.

### Embodiment 6

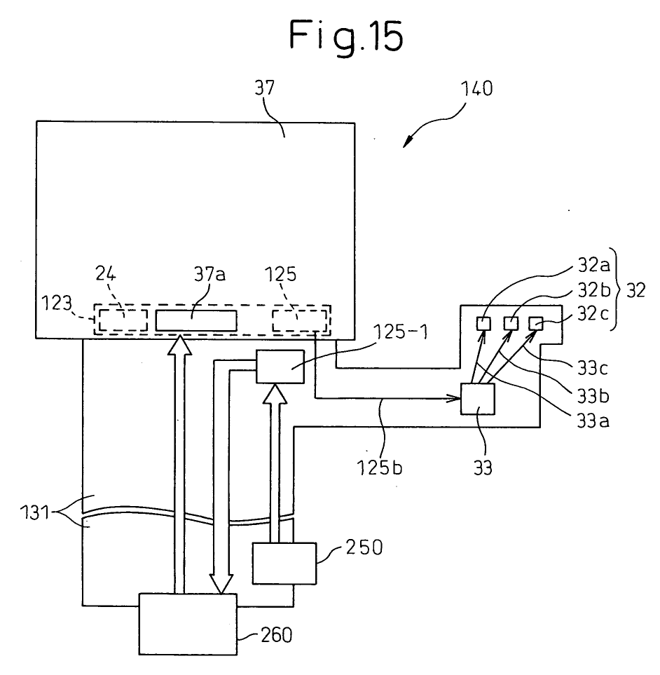

A sixth embodiment of the present invention will be described with reference to FIG. 15. FIG. 15 is a rear view of a display apparatus 140 according to the sixth embodiment.

The display apparatus 140 of the sixth embodiment is a modification of the display apparatus 40 of the first embodiment. Accordingly, in FIG. 15, components identical to those in the display apparatus 40 shown in FIG. 7 are designated by the same reference numerals. The display apparatus 140 differs from the display apparatus 40 in that the adjusting value setting section 25-1 is replaced by an adjusting value setting IC 125-1. The adjusting value setting IC 125-1 includes a memory (for example, an E²ROM) for storing set value data and an interface (for example, a plurality of terminals) for inputting set values. After the settings have been made in accordance with the method described in the first embodiment, the user stores the set value data in the memory within the adjusting value setting IC 125-1 by using a predetermined input device 250 (for example, a personal computer or an E²ROM writer having a probe connectable to the set value input interface). Accordingly, the adjusting value setting IC 125-1 can perform the same function as the adjusting value setting section 25-1 described in the first embodiment. The external control circuit 260 connected via the FPC 131 takes out the set value data from the memory within the adjusting value setting IC 125-1, and transfers the taken out data to the adjusting circuit 125 via the interface of the panel driving IC 123. The adjusting circuit 125 has the same function as the adjusting circuit 25 of the display apparatus 40, except that the adjusting circuit 125 is configured to be able to acquire the set value data via the control circuit 260.

The other configuration of the sixth embodiment, for example, the display panel 22, the display panel driving circuit 24, the red, green, and blue LEDs 32a, 32b, and 32c, the light source driving IC 33, the supporting frame 37, etc. are the same as those in the display apparatus 40, and the description of such components will not be repeated. Further, the method of folding the FPC 131 and the method of positioning the red, green, and blue LEDs 32a, 32b, and 32c are also the same as those employed for the display apparatus 40, and therefore, the description thereof will not be repeated.

In the display apparatus 140 of the sixth embodiment, the display panel driving circuit 24 outputs a timing signal (for example, a clock signal) to the adjusting circuit 125. The adjusting circuit 125, which is supplied with the timing signal and the adjusting value data for optimum pulse widths taken out from the adjusting value setting IC 125-1 via the external control circuit 260, outputs a signal 125b to the light source driving IC 33 mounted on the FPC 131. The red, green, and blue LEDs 32a, 32b, and 32c emite, each for a predetermined pulse duration, by sequentially switching from one to another in accordance with the light source drive timing signals 33a, 33b, and 33c supplied from the light source driving IC 33. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 125-1.

In the present embodiment, as the light source is driven by using the timing signal (clock signal) input to the panel driving IC 123, as in the first and other embodiments, the number of conductive patterns to be brought out of the external control circuit 260 can be reduced. Furthermore, in the present embodiment, as the adjusting value setting section 25-1 in the first embodiment is replaced by the adjusting value setting IC, the number of conductive patterns to be brought out of the panel driving IC 123 can be further reduced, while also reducing the required area of the FPC. Further, since the adjusting value setting IC 125-1 comprising an E²ROM, etc. is mounted near the display panel 22, the individual set value data need not be stored on the motherboard of the external control circuit 260, etc. and the configuration can thus be simplified.

### Embodiment 7

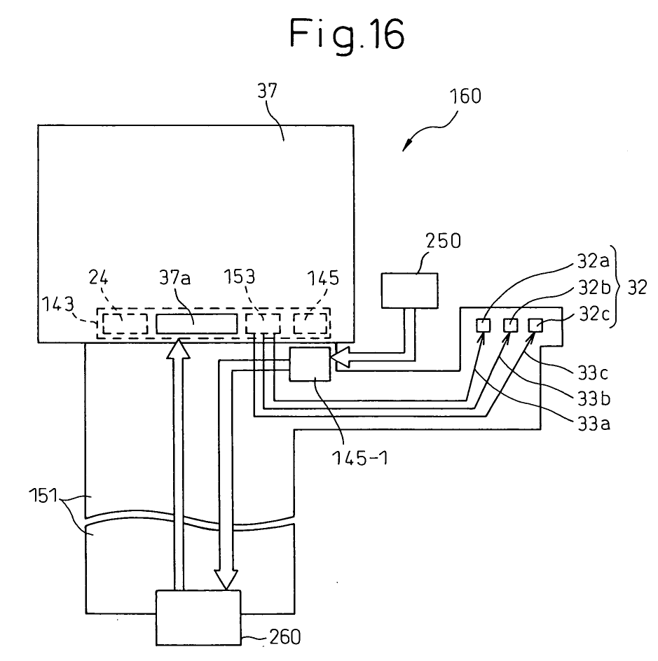

A seventh embodiment of the present invention will be described with reference to FIG. 16. FIG. 16 is a rear view of a display apparatus 160 according to the seventh embodiment.

The display apparatus 160 of the seventh embodiment is a modification of the display apparatus 40 of the first embodiment. Accordingly, in FIG. 16, components identical to those in the display apparatus 40 shown in FIG. 7 are designated by the same reference numerals. The display apparatus 160 differs from the display apparatus 40 in that the circuitry incorporated in the light source driving IC for the display apparatus 40 is incorporated as a light source driving circuit 153 in the panel driving IC 143, and in that the adjusting value setting section 25-1 is replaced by an adjusting value setting IC 145-1.

That is, in the present embodiment, the panel driving IC 143 contains the display panel driving circuit 24, the light source driving circuit 153, and the adjusting circuit 145. Accordingly, the timing signal 33a for the red LED 32a, the timing signal 33b for the green LED 32b, and the timing signal 33c for the blue LED 32c are output from the panel driving IC 143.

The adjusting value setting IC 145-1 includes a memory (for example, an E²ROM) for storing set value data and an interface (for example, a plurality of terminals) for inputting set values. After the settings have been made in accordance with the method described in the first embodiment, the user stores the set value data in the memory within the adjusting value setting IC 145-1 by using a predetermined input device 250 (for example, a personal computer or an E²ROM writer having a probe connectable to the set value input interface). Accordingly, the adjusting value setting IC 145-1 can perform the same function as the adjusting value setting section 25-1 described in the first embodiment. The external control circuit 260 connected via the FPC 151 taken out the set value data from the memory within the adjusting value setting IC 145-1, and transfers the taken out data to the adjusting circuit 145 via the interface of the panel driving IC 143. The adjusting circuit 145 has the same function as the adjusting circuit 25 of the display apparatus 40, except that the adjusting circuit 145 is configured to be able to acquire the set value data via the control circuit 260.

The configuration of the present embodiment, for example, the display panel 22, the display panel driving circuit 24, the red, green, and blue LEDs 32a, 32b, and 32c, the supporting frame 37, etc. are the same as those in the display apparatus 40, and the description of such components will not be repeated here. Further, the method of folding the FPC 151 and the method of positioning the red, green, and blue LEDs 32a, 32b, and 32c are also the same as those employed for the display apparatus 40, and therefore, the description thereof will not be repeated here.

In the display apparatus 160 of the seventh embodiment, the display panel driving circuit 24 outputs a timing signal (for example, a clock signal) to the adjusting circuit 145. The adjusting circuit 145 supplies to the light source driving circuit 153 within the same panel driving IC 143 a signal that contains the timing signal and the adjusting value data for optimum pulse widths taken out from the adjusting value setting IC 145-1 via the external control circuit 260. The red, green, and blue LEDs 32a, 32b, and 32c emit, each for a predetermined pulse duration, by sequentially switching from one to another in accordance with the light source drive timing signals 33a, 33b, and 33c supplied from the light source driving circuit 153 contained in the panel driving IC 143. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 145-1.

In the present embodiment, as the light source is driven by using the timing signal (clock signal) input to the panel driving IC 143, as in the first and other embodiments, the number of conductive patterns to be brought out of the external control circuit 260 can be reduced. Furthermore, in the present embodiment, as the circuitry incorporated in the light source driving IC 33 mounted as an independent component in the first embodiment is incorporated in the panel driving IC 143, the number of conductive patterns to be brought out of the panel driving IC 143 can be further reduced. Moreover, in the present embodiment, as the adjusting value setting section 25-1 in the first embodiment is replaced by the adjusting value setting IC, the number of conductive patterns to be brought out of the panel driving IC 143 can be further reduced, while also reducing the required area of the FPC. Further, as the adjusting value setting IC 145-1 comprising an E²ROM, etc. is mounted near the display panel 22, the individual set value data need not be stored on the motherboard of the external control circuit 260, etc. and the configuration can thus be simplified.

### Embodiment 8

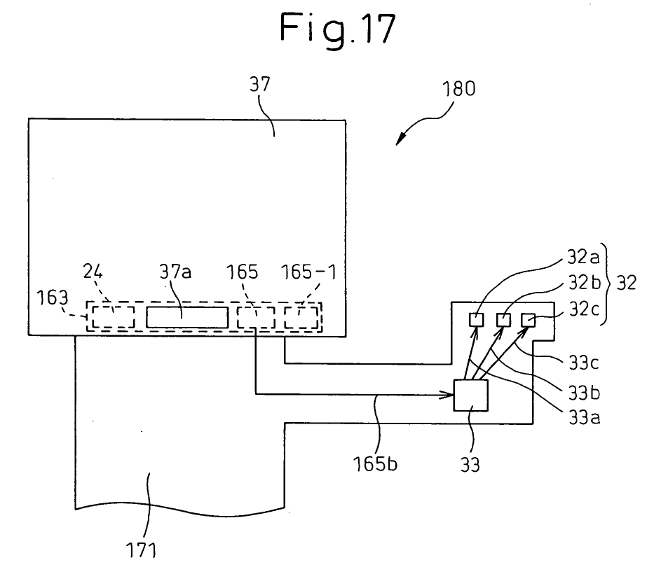

An eighth embodiment of the present invention will be described with reference to FIG. 17. FIG. 17 is a rear view of a display apparatus 180 according to the eighth embodiment.

The display apparatus 180 of the eighth embodiment is a modification of the display apparatus 40 of the first embodiment. Accordingly, in FIG. 17, components identical to those in the display apparatus 40 shown in FIG. 7 are designated by the same reference numerals. The display apparatus 180 differs from the display apparatus 40 in that a circuit having the function of the adjusting value setting section 25-1 is included in the panel driving IC 163 as an adjusting value setting circuit 165-1.

That is, in the present embodiment, the panel driving IC 163 contains the display panel driving circuit 24, the adjusting circuit 165, and the adjusting value setting circuit 165-1. The adjusting value setting circuit 165-1 includes a memory (for example, an E²ROM) for storing set value data and an interface (for example, a plurality of terminals) for inputting set values. After the settings have been made in accordance with the method described in the first embodiment, the user stores the set value data in the memory within the adjusting value setting circuit 165-1 by using a predetermined input device (for example, a personal computer or an E²ROM writer having a probe connectable to the set value input interface). Accordingly, the adjusting value setting circuit 165-1 can perform the same function as the adjusting value setting section 25-1 described in the first embodiment. The adjusting circuit 165 has the same function as the adjusting circuit 25 of the display apparatus 40, except that the adjusting circuit 165 is configured to be able to take out the set value data from the memory within the adjusting value setting circuit 165-1.

The configuration of the present embodiment, for example, the display panel 22, the display panel driving circuit 24, the red, green, and blue LEDs 32a, 32b, and 32c, the supporting frame 37, etc. are the same as those in the display apparatus 40, and the description of such components will not be repeated here. Further, the method of folding the FPC 171 and the method of positioning the red, green, and blue LEDs 32a, 32b, and 32c are also the same as those employed for the display apparatus 40, and therefore, a description thereof will not be repeated.

In the display apparatus 180 of the eighth embodiment, the display panel driving circuit 24 outputs a timing signal (for example, a clock signal) to the adjusting circuit 165. The adjusting circuit 165 supplies to the light source driving IC 33 mounted on the FPC 171 a signal 165b that contains the timing signal and the adjusting value data for optimum pulse widths stored in the adjusting value setting circuit 165-1 within the panel driving IC 163. The red, green, and blue LEDs 32a, 32b, and 32c emit, each for a predetermined pulse duration, by sequentially switching from one to another in accordance with the light source drive timing signals 33a, 33b, and 33c supplied from the light source driving IC 33. The brightness balance of the R, G, and B colors is thus adjusted, and white light of good chromaticity or brightness can be obtained. Here, the emission timing of each of the red, green, and blue LEDs may be adjusted by the adjustment of the adjusting value setting circuit 165-1.

In the present embodiment, as the light source is driven by using the timing signal (clock signal) input to the panel driving IC 163, as in the first and other embodiments, the number of conductive patterns to be brought out of the panel driving IC 163 can be reduced. Furthermore, in the present embodiment, as the adjusting value setting section 25-1 in the first embodiment is replaced by the adjusting value setting circuit which is included in the panel driving IC 163, the number of conductive patterns to be brought out of the panel driving IC 163 can be further reduced, while also reducing the required area of the FPC.

### Embodiment 9

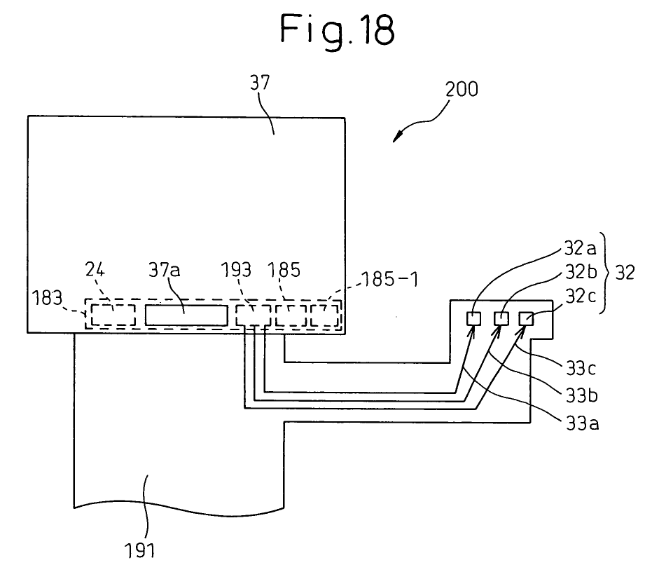

A ninth embodiment of the present invention will be described with reference to FIG. 18. FIG. 18 is a rear view of a display apparatus 200 according to the ninth embodiment.

The display apparatus 200 of the ninth embodiment is a modification of the display apparatus 40 of the first embodiment. Accordingly, in FIG. 18, components identical to those in the display apparatus 40 shown in FIG. 7 are designated by the same reference numerals. The display apparatus 200 differs from the display apparatus 40 in that a circuit having the function of the adjusting value setting section 25-1 of the display apparatus 40 is included in the panel driving IC 183 as an adjusting value setting circuit 185-1, and in that the circuit incorporated in the light source driving IC 33 of the display apparatus 40 is included in the panel driving IC 183 as a light source driving circuit 193.

That is, in the present embodiment, the panel driving IC 183 contains the display panel driving circuit 24, the light source driving circuit 193, the adjusting circuit 185, and the adjusting value setting circuit 185-1. The adjusting value setting circuit 185-1 includes a memory (for example, an E²ROM) for storing set value data and an interface (for example, a plurality of terminals) for inputting set values. After the settings have been made in accordance with the method described in the first embodiment, the user stores the set value data in the memory within the adjusting value setting circuit 185-1 by using a predetermined input device (for example, a personal computer or an E²ROM writer having a probe connectable to the set value input interface). Accordingly, the adjusting value setting circuit 185-1 can perform the same function as the adjusting value setting section 25-1 described in the first embodiment. The adjusting circuit 185 has the same function as the adjusting circuit 25 of the display apparatus 40, except that the adjusting circuit 185 is configured to be able to take out the set value data from the memory within the adjusting value setting circuit 185-1.

Further, in the present invention, as the light source driving circuit 193 is included in the panel driving IC 183, the light source drive timing signals 33a, 33b, and 33c are output from the panel driving IC 183.

The configuration of the present embodiment, for example, the display panel 22, the display panel driving circuit 24, the red, green, and blue LEDs 32a, 32b, and 32c, the supporting frame 37, etc. are the same as those in the display apparatus 40, and the description of such components will not be repeated. Further, the method of folding the FPC 191 and the method of positioning the red, green, and blue LEDs 32a, 32b, and 32c are also the same as those employed for the display apparatus 40, and therefore, the description thereof will not be repeated.

In the display apparatus 200 of the ninth embodiment, the display panel driving circuit 24 outputs a timing signal (for example, a clock signal) to the adjusting circuit 185. The adjusting circuit 185 supplies to the light source driving circuit 193 within the same panel driving IC 183 a signal that contains the timing signal and the adjusting value data for optimum pulse widths stored in the adjusting value setting circuit 185-1 within the panel driving IC 183. The red, green, and blue LEDs 32a, 32b, and 32c emit, each for a predetermined pulse duration, by sequentially switching from one to another in accordance with the light source drive timing signals 33a, 33b, and 33c supplied from the light source driving circuit 193 contained in the panel driving IC 183. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 185-1.

In the present embodiment, as the light source is driven by using the timing signal (clock signal) input to the panel driving IC 183, as in the first and other embodiments, the number of conductive patterns to be brought out of the panel driving IC 183 can be reduced. Furthermore, in the present embodiment, as the circuitry incorporated in the light source driving IC 33 mounted as an independent component in the first embodiment is incorporated in the panel driving IC 183, the number of conductive patterns to be brought out of the panel driving IC 183 can be further reduced. Further, in the present embodiment, as the adjusting value setting section 25-1 in the first embodiment is replaced by the adjusting value setting circuit which is included in the panel driving IC 183, the number of conductive patterns to be brought out of the panel driving IC 183 can be further reduced, while also reducing the required area of the FPC.

### Embodiment 10

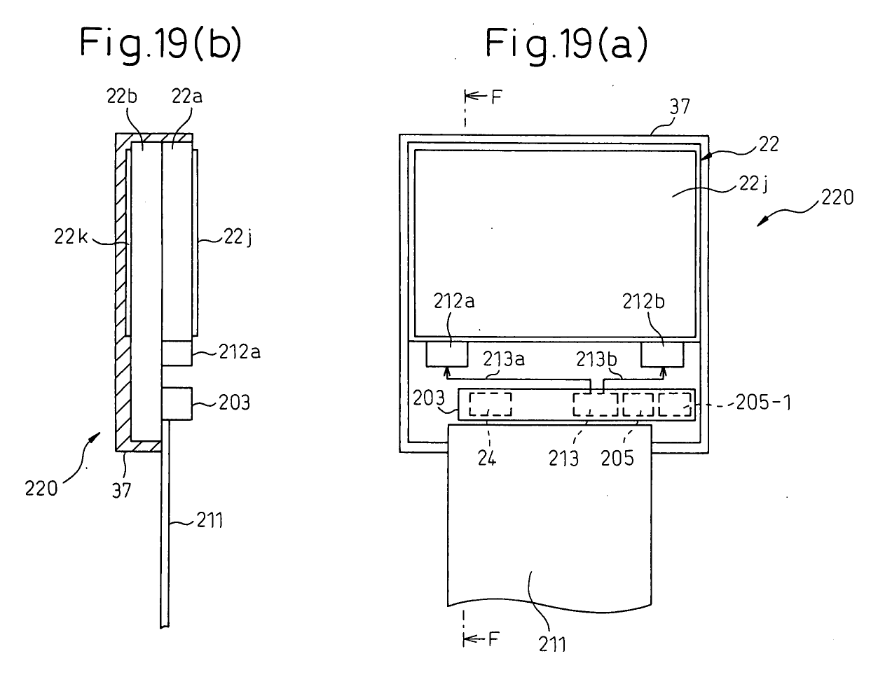

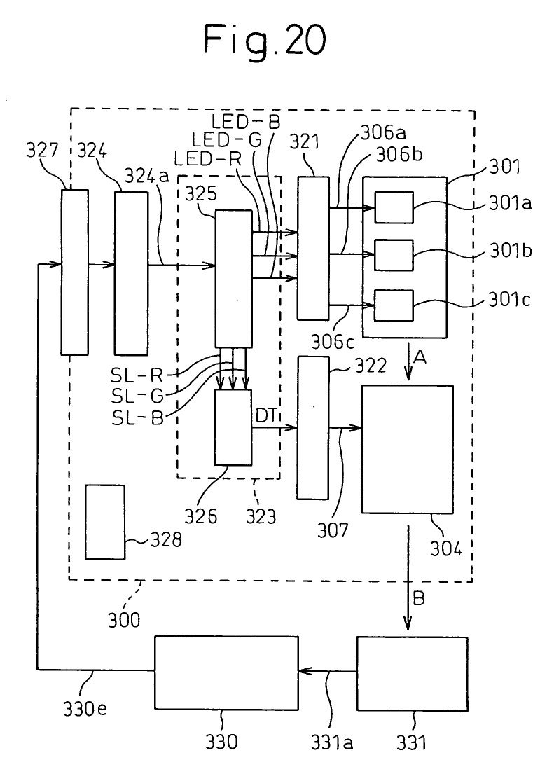

A 10th embodiment of the present invention will be described with reference to FIG. 19. FIG. 19(a) is a plan view of a display apparatus 220 according to the 10th embodiment, and FIG. 19(b) is a cross-sectional view taken along line F-F of FIG. 19(a).

The display apparatus 220 of the 10th embodiment is a modification of the display apparatus 40 of the first embodiment. Accordingly, in FIG. 19, components identical to those in the display apparatus 40 shown in FIG. 7 are designated by the same reference numerals. The display apparatus 220 differs from the display apparatus 40 in that a circuit having the function of the adjusting value setting section 25-1 of the display apparatus 40 is included in the panel driving IC 203 as an adjusting value setting circuit 205-1, in that the circuit incorporated in the light source driving IC 33 of the display apparatus 40 is included in the panel driving IC 203 as a light source driving circuit 213, and in that the light source is mounted on the display panel 22.

That is, in the present embodiment, the panel driving IC 203 contains the display panel driving circuit 24, the light source driving circuit 213, the adjusting circuit 205, and the adjusting value setting circuit 205-1. The adjusting value setting circuit 205-1 includes a memory (for example, an E²ROM) for storing set value data and an interface (for example, a plurality of terminals) for inputting set values. After the settings have been made in accordance with the method described in the first embodiment, the user stores the set value data in the memory within the adjusting value setting circuit 205-1 by using a predetermined input device (for example, a personal computer or an E²ROM writer having a probe connectable to the set value input interface). Accordingly, the adjusting value setting circuit 205-1 can perform the same function as the adjusting value setting section 25-1 described in the first embodiment. The adjusting circuit 205 has the same function as the adjusting circuit 25 of the display apparatus 40, except that the adjusting circuit 205 is configured to be able to take out the set value data from the memory within the adjusting value setting circuit 205-1.

Further, in the present embodiment, the light source drive timing signals 213a and 213b are output from the panel driving IC 203, because the light source driving circuit 213 is included in the panel driving IC 203. The light sources 212a and 212b are mounted on an extended portion of the bottom substrate 22b extending outwardly beyond a side edge of the top substrate 22a of the display panel 22, and are positioned in close vicinity to the edge face of the top substrate 22a. The light sources 212a and 212b are each a so-called three-in-one type LED containing a red LED, a green LED, and a blue LED in one package. That is, in the present embodiment, two sets of red, green, and blue LEDs respectively corresponding to the red, green, and blue LEDs 32a, 32b, and 32c in the first embodiment are mounted on the display panel 22, not on the FPC. It is also understood that the light source drive timing signals 213a and 213b respectively contain the same timing signals for the red, green, and blue LEDs (see FIG. 3).

The configuration of the present embodiment, for example, the display panel 22, the display panel driving circuit 24, the supporting frame 37, etc. are the same as those in the display apparatus 40, and the description of such components will not be repeated here.

In the display apparatus 220 of the 10th embodiment, the display panel driving circuit 24 outputs a timing signal (for example, a clock signal) to the adjusting circuit 205. The adjusting circuit 205 supplies to the light source driving circuit 213 within the same panel driving IC 203 a signal that contains the timing signal and the adjusting value data for optimum pulse widths stored in the adjusting value setting circuit 205-1 within the panel driving IC 203. The red, green, and blue LEDs contained in the light sources 212a and 212b emit, each for a predetermined pulse duration, by sequentially switching from one to another in accordance with the light source drive timing signals 213a and 213b supplied from the light source driving circuit 213 contained in the panel driving IC 203. The brightness balance of the R, G, and B colors is thus adjusted, and white light of good chromaticity or brightness can be obtained. Here, the emission timing of each of the red, green, and blue LEDs may be adjusted by the adjustment of the adjusting value setting section 205-1.

In the present embodiment, as the light source is driven by using the timing signal (clock signal) input to the panel driving IC 203, as in the first and other embodiments, the number of conductive patterns, to be brought out of the panel driving IC 203, can be reduced. Furthermore, in the present embodiment, as the circuitry incorporated in the light source driving IC 33 mounted as an independent component in the first embodiment is incorporated in the panel driving IC 203, the number of conductive patterns to be brought out of the panel driving IC 203 can be further reduced. Moreover, in the present embodiment, as the adjusting value setting section 25-1 in the first embodiment is replaced by the adjusting value setting circuit which is included in the panel driving IC 203, the number of conductive patterns to be brought out of the panel driving IC 203 can be further reduced, while also reducing the required area of the FPC. Further, in the present embodiment, as the light source mounted on the FPC in the first embodiment is mounted on the display panel at a position near the panel driving IC 203, the display apparatus can be made compact.

In the first to fourth and sixth to ninth embodiments described above, the display apparatus has been described as using a light guiding plate, but the display apparatus of the present invention may be constructed without using a light guiding plate but by mounting a plurality of LEDs (for example, red, green, and blue LEDs, etc.) directly behind the display panel. Further, the first to fourth and sixth to ninth embodiments have been described for the case where the display apparatus is illuminated by backlighting, but frontlighting or sidelighting may be used instead of backlighting. In that case also, the effect of the present invention can be obtained.

In the first to 10th embodiments described above, glass substrates have been used for the top and bottom substrates, but instead, plastic substrates may be used for the top and bottom substrates.

What is claimed is:

1. A field-sequential type display apparatus comprising:
a liquid crystal display panel which displays red, green, and blue component images by sequentially switching from one image to another;
a panel driving section which outputs a timing signal and a panel driving signal for driving said liquid crystal display panel;
a light source having a red LED, a green LED, and a blue LED;
a setting section for setting the brightness of each of said red, green, and blue LEDs;
an adjusting section which, based on the setting made by said setting section, outputs adjusting data for adjusting the brightness of each of said red, green, and blue LEDs; and
a light source driving section which makes, based on said adjusting data, said red LED, said green LED, and said blue LED emit by sequentially switching from one LED to another in synchronism with said timing signal.

2. The display apparatus according to claim 1, wherein said setting section has a plurality of conductive pattern circuits, and said setting in said setting section is done by making non-conductive at least one conductive pattern circuit selected from among said plurality of conductive pattern circuits.

3. The display apparatus according to claim 1, wherein said setting section has a plurality of non-conductive pattern circuits, and said setting in said setting section is done by making conductive at least one non-conductive pattern circuit selected from among said plurality of non-conductive pattern circuits.

4. The display apparatus according to claim 1, wherein said setting section has a memory, and said setting in said setting section is done by writing to said memory.

5. The display apparatus according to claim 1, further comprising an external circuit connecting board for transmitting display data to said panel driving section.

6. The display apparatus according to claim 5, wherein said light source, said setting section, and said light source driving section are provided on said external circuit connecting board.

7. The display apparatus according to claim 5, wherein said external circuit connecting board comprises a first FPC board and a second FPC board, and wherein said light source and said light source driving section are provided on said first FPC board, while said setting section is provided on said second FPC board.

8. The display apparatus according to claim 7, wherein said first FPC board and said second FPC board are formed integrally.

9. The display apparatus according to claim 1, wherein said panel driving section and said adjusting section are provided within the same IC.

10. The display apparatus according to claim 1, wherein said panel driving section, said light source driving section, and said adjusting section are provided within the same IC.

11. The display apparatus according to claim 1, wherein said panel driving section, said adjusting section, and said setting section are provided within the same IC.

12. The display apparatus according to claim 1, wherein said panel driving section, said light source driving section, said adjusting section, and said setting section are provided within the same IC.

13. A display apparatus comprising:
a display panel which displays a plurality of color component images by sequentially switching from one image to another;
a panel driving section which outputs a timing signal and a panel driving signal for driving said display panel;
a light source which emits a plurality of colored lights; and
a light source driving section which outputs a driving signal for driving said light source in synchronism with said timing signal.

14. A display apparatus comprising:
a panel driving section which outputs a panel driving signal for driving a display panel;
a light source which emits a plurality of colored lights; and
an adjusting section which outputs adjusting data for adjusting the brightness of each of said plurality of colored lights to be emitted from said light source, wherein
said panel driving section and said adjusting section are provided within the same IC.

15. The display apparatus according to claim 14, further comprising a light source driving section which, based on said adjusting data, outputs a driving signal for driving said light source, and wherein
said panel driving section, said light source driving section, and said adjusting section are provided within the same IC.

16. The display apparatus according to claim 14, further comprising a setting section for setting the brightness of each of said plurality of colored lights to be emitted from said light source, and wherein
based on the setting made by said setting section, said adjusting section outputs the adjusting data for adjusting the brightness of each of said plurality of colored lights to be emitted from said light source, and
said panel driving section, said setting section, and said adjusting section are provided within the same IC.

17. The display apparatus according to claim 14, further comprising:
a setting section for setting the brightness of each of said plurality of colored lights to be emitted from said light source; and
a light source driving section which, based on said adjusting data, outputs a driving signal for driving said light source, and wherein
based on the setting made by said setting section, said adjusting section outputs the adjusting data for adjusting the brightness of each of said plurality of colored lights to be emitted from said light source, and
said panel driving section, said light source driving section, said setting section, and said adjusting section are provided within the same IC.

18. A display apparatus comprising:
a panel driving section which outputs a timing signal and a panel driving signal for driving a display panel;
a light source which emits a plurality of colored lights;
an adjusting section which outputs adjusting data for adjusting the brightness of each of said plurality of colored lights to be emitted from said light source; and
a light source driving section which outputs a driving signal for driving said light source in synchronism with said timing signal, wherein
said panel driving section and said adjusting section are provided within the same IC.
